(19) United States
(12) Patent Application Publication
(10) Pub. No.: US 2021/0297155 A1
(43) Pub. Date: Sep. 23, 2021

(54) SYSTEMS AND METHODS FOR HIGH SPEED INFORMATION TRANSFER

(71) Applicant: Joseph Anthony Sorge, Jackson, WY (US)

(72) Inventor: Joseph Anthony Sorge, Jackson, WY (US)

(21) Appl. No.: 17/109,025

(22) Filed: Dec. 1, 2020

Related U.S. Application Data
(60) Provisional application No. 62/942,641, filed on Dec. 2, 2019.
(60) Provisional application No. 63/011,173, filed on Apr. 16, 2020.

(51) Int. Cl. H04B 10/25

(52) U.S. Cl. CPC H04B 10/25

(57) ABSTRACT

Described herein are systems and methods of information transfer using transmission of light through a moving medium in order to achieve higher speeds of information transfer. The medium may be moved through a conduit, either in one direction, or in an oscillating back-and-forth fashion. Light is transmitted through the moving medium in the conduit.

### BACKGROUND

### Field of the Invention

The present invention is related to the field of light-based information transfer.

### Description of the Related Art

Electromagnetic communication between two distant points is generally believed to be limited by the speed of light in a vacuum (c). In addition, when the electromagnetic wave is transmitted through a medium, the speed of the wave is slowed by a factor corresponding to the refractive index of the medium (v=c/n, where n is the refractive index). For example, a typical core in a fiber optic cable has a refractive index of about 1.5, reducing the maximum possible speed for information transfer by two thirds. Thus, there is a need for improved systems and methods that permit the transmission of information at speeds faster than attainable with current systems.

### SUMMARY OF THE INVENTION

The present disclosure is directed to systems and methods of information transfer using transmission of radiation (e.g., light) through a moving medium in order to achieve higher speeds of information transfer. Some embodiments include a system for transmitting information from a first location to a second location, comprising a conduit running between the first and second locations; a material within the conduit; a material mover in fluid communication with the conduit; a radiation source at the first location configured to transmit radiation through the material in the conduit; and a radiation detector at the second location configured to detect the light. Other embodiments include a method of transmitting information from a first location to a second location, the method comprising providing a conduit between the first and second locations; moving material within the conduit at a speed of at least 0.001 c, wherein c is the speed of light in vacuum; and transmitting light encoding the information through the moving material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: The components of the velocity of light in a transverse “light clock” according to Einstein. A) As perceived by Observer 1 traveling in a moving inertial frame of reference (“IRF”). B) As perceived by Observer 0 who sees Observer 1's light clock moving in the x-direction. v represents the speed at which the moving frame of reference is traveling in the x-direction. c′_{y} and t′ represent the speed of light and travel time, as perceived by Observer 1. t is the travel time as perceived by Observer 0. γ is the Lorentz factor at velocity v.

FIG. 2: The components of the velocity of light in a longitudinal “light clock” according to Einstein. A) As perceived by Observer 1 traveling in a moving reference frame. B) As perceived by Observer 0 who sees Observer 1's longitudinal light clock moving in the x-direction. v represents the speed at which the moving reference frame is traveling in the x-direction. dt_{d} represents the time light travels downstream, and dt_{y} represents the time that light travels upstream. γ is the Lorentz factor at velocity v.

FIG. 3: Classical primary Doppler effect. Diagram illustrating how receivers moving leftward at speed v/c=0.5 will perceive a circular wave of light emitted by a stationary source at point S located at coordinate (0,0). At the end of the first period, the receivers lie on the solid blue circle, which represents the first wave crest. At the moment a second wave crest emerges from the stationary source at point S, the receivers begin to move leftward. Numerical values are included as a concrete example. A receiver positioned on the solid blue circle at coordinate (1,0) on the horizontal axis will travel leftward and collide with the second wavefront (dashed red line) after the receiver has traveled one third the distance toward point S and the second wave front has traveled rightward (at speed c) two thirds the distance between point S and point (1,0). The moving receiver will perceive a wavelength of 0.667 units between the second (dashed) wavefront and point S. A receiver initially positioned at (−1,0) will travel leftward at v/c=0.5 until overcome by a second wavefront traveling at speed c leftward from point S. The wavefront will reach this second receiver after the receiver has reached position (−2,0) on the horizontal axis. This second receiver will observe a wavelength of 2 between the second wavefront and point S. A receiver initially positioned at point R having coordinates (0,1) will travel leftward at speed v/c=0.5 until reached by a second wavefront starting at position S and reaching the receiver at point I having approximate coordinates (−0.557,1). The receiver that originates at point R will perceive a wavelength of 1.1547 when the second wavefront reaches the receiver at point I.

FIG. 4. Diagram illustrating the derivation of the classical aberration angle. A receiver initially positioned at point R moves leftward at speed vt. Point R is one wavelength distance (cT₀ where T₀ is one period) from a stationary source at point S, the ray connecting points S and R forming an angle φ with the horizontal axis. Light travels outward from point S where it intersects with the receiver at point I. The ray connecting points S to I forms an angle φ′ with the horizontal axis. φ′ is considered the classical aberration angle as seen by the receiver when it reaches point I.

FIG. 5: The relativistic Doppler effect for a moving receiver is derived by assuming that receivers are initially located on the dotted green ellipse, rather than on the solid blue circle as in FIG. 3. The dotted green circle has been contracted along the horizontal axis by a factor of γ_{L}, such that its major vertical axis has a radius of 1.0 and its minor horizontal axis has a radius of 1/γ_{L}. For example, instead of the rightmost receiver starting at coordinate (1,0) as in FIG. 3, the rightmost receiver will begin at position (0.866,0) (approximately). If such a receiver proceeds leftward while a wave of light is emitted from point S (0,0) traveling rightward at speed c, they will meet at coordinate (0.577,0) approximately. Each receiver lying on the dotted green ellipse will travel leftward at speed v/c=0.5, while light will radiate at speed c from point S. The dashed red ellipse is where the receivers will intersect with the light radiating from point S. The coordinates of the dashed red ellipse exactly match those predicted by the relativistic Doppler equation for moving receivers.

FIG. 6: The emission of light from a source S that travels a distance vT₀ to position S′ in one period. Light emitted at point S travels at speed γ_{φ}c, tracing a radius of length r=γ_{φ}cT₀ shown as a red ellipse. The distance between S′ and the wavefront at the end of a period is the wavelength λᵣ, between the initial wavefront emitted at point S and the subsequent wavefront emitted at point S′. A receiver at point I will perceive the light to have originated at point S even though the source has moved to point S′ while the light traveled from point S to point I. Since the Doppler effect for a moving source occurs at the moment of emission, the angle φ is what is used to compute the Doppler effect. Therefore there is no need to compute an aberration angle for purposes of computing wavelengths or frequencies coming from a moving source as observed by a stationary receiver. For receivers that are far from the source (many wavelengths), the distance becomes small as compared to the r distance as φ approaches π/2. For the setup in FIG. 6) where the receiver is only one wavelength from the source, this is not a concern. But as the distance between source and receiver increases, the angle opposite the vT₀ distance approaches zero and vT₀ scales as vT₀ cos φ.

FIG. 7: Plots of wavefronts predicted by various Doppler equations. A) Wavefronts predicted by the relativistic Doppler equation for receivers moving leftward at speed v/c=0.5. Aberration angles were used to compute the wavelengths, which is appropriate when the receiver is moving. Note the compression to the right and expansion to the left caused by the motion of the receivers relative to the stationary source. B) Wavefronts predicted by the alternative Doppler equation for receivers moving leftward at speed v/c=03. Note that the compression to the right is not as extreme, and the expansion to the left is greater, reflecting the lack of length contraction along the horizontal axis. C) Wavefronts predicted by the relativistic Doppler equation for a source moving rightward at speed v/c=0.5. Note the compression to the right is unusual in shape. This pattern was generated with the classical relativistic Doppler equation using normal angles (which are the relevant angles for a moving source). The radial distances between the origin and points on the ellipses in panels A and C are the same, but the spatial locations are different due to the aberration angles. The differences in shapes between the plots in panels A and C raise concerns with respect to the principle of relativity. D) Wavefronts predicted by the alternative Doppler equation for a source moving rightward at speed v/c=0.5. Note the regularity of the wave patterns. The alternative model does not support the principle of relativity, and so the different shapes between panels B and D is as expected.

FIG. 8: The graph compares the speed of light through moving water predicted by Fizeau's equation, special relativity's velocity addition formula, and the alternative velocity addition formula. Water speed is expressed as a fraction of c. Water speed is negative when it is flowing antiparallel (against) to the direction of light velocity. Note that special relativity predicts a significantly asymmetrical, non-linear change in light speed in response to negative water speeds.

FIG. 9A: The shift in wavelength, in meters, due to the first-order Doppler effect measured in the Ives Stilwell experiment compared to the shift predicted by special relativity and by the alternative model (“revised”). FIG. 9B: The shift in wavelength, in meters, due to the higher-order Doppler effect measured in the Ives Stilwell experiment compared to the shift predicted by special relativity and by the alternative model (“revised”).

FIG. 10A: A stationary IRF in which a central light source (green star) emits light at the same wavelength, frequency, and speed in all direction. Concentric circles represent light waves. Dotted black arrows represent photons being emitted vertically and to the right horizontally. The vertical photon aligns with vertical grid line zero. Receivers R1 and R3 are within the IRF and detect light of the same wavelength, frequency, and speed. Receiver R2 is stationary, but not in the same IRF. FIG. 10B: The same IRF as in FIG. 10A, but now in motion to the right. Receivers R1 and R3 move rightward, together with the source. For clarity, the first order Doppler effect is not shown in this figure. Only the higher order Doppler effect is shown. Receiver R2 is not in the same IRF and remains stationary on vertical grid line 2. The vertically moving photon shown in FIG. 10A has now reached receiver R3 as receiver R3 crosses vertical grid line zero. Photons emitted vertically from the source will continue to reach receiver R3 at a right angle to the direction of IRF motion. Photons emitted rightward from the source reach both receivers R1 and R2. The source is shown in red instead of green, to symbolize the higher order Doppler wavelength shift of the source. If length contraction were real, then receiver R1 should not see the higher order Doppler effect. This is symbolized as a green color at receiver R1. Receiver R2 is stationary, and represents a stationary observer in the Ives Stilwell experiment, where a higher order Doppler wavelength red shift was observed. The postulated lack of red shift at receiver R1 and the measured red shift at receiver R2 are mutually inconsistent. Given that special relativity postulates no length contraction in the direction transverse to IRF motion, receiver R3 should detect a higher order Doppler wavelength red shift. The detection of different wavelengths by receivers R1 and R3 would also violate one of Einstein's postulates.

### DETAILED DESCRIPTION

While not being bound by any particular theory, it is known that the speed of light through a medium increases relative to a stationary frame when the medium itself is moving relative to the stationary frame, parallel the direction of light transmission. However it is widely believed that light speed cannot exceed speed “c” in our universe. It is now determined that in some cases, effective superluminal speeds (greater than c) may be obtained by moving the medium relative to the stationary frame at very high speeds. Accordingly, by transmitting light through a moving medium, information may be transmitted at speeds higher than previously attainable.

In one embodiment, a conduit is provided between a first location and a second location. The conduit is filled with a medium, which is then moved generally along a central axis of the conduit. Light is then transmitted through the medium in the conduit from the first location and then detected at the second location. In some embodiments, information is encoded within the light, such as by frequency modulation, amplitude modulation, phase modulation, or pulse modulation.

The conduit may be constructed from any suitable material, including a metal, glass, or polymer. In some embodiments, the conduit is a closed loop such that two lengths of conduit run between the first and second locations which are then in fluid communication with each other at both the first and second locations. In some embodiments, light is transmitted from the first location using a laser and detected at the second location using a photodetector. In some embodiments, the conduit includes windows (e.g., made of glass) at the first and second locations to permit light to pass in and out of the conduit. In other embodiments, the light source and detector are incorporated within the conduct, with appropriate electronic cabling passing through a side wall of the conduit. Light transmission and detection electronics may be substantially as is used in current fiber optic systems. In some embodiments, the inner surface of the conduit includes a material that is reflective or has an index of refraction that is such to permit total internal reflection of the light as it passes through the medium in the conduit.

In some embodiments, the medium within the conduit has an index of refraction less than 2, 1.5, 1.4, 1.3, 1.2, 1.1, 1.05, 1.01, 1.001, 1.0001, 1.00001, 1.000001, or a range between any two of these values. In some embodiments, the medium within the conduit is a fluid, such as a gas. In some embodiments, the medium within the conduit is helium. In some embodiments, the medium within the conduit is air. The medium may be moved within the conduit using any suitable mechanism for moving fluids, such a variety of pumps. In some embodiments, the medium is moved substantially in one direction through the conduit. In such embodiments, the direction of medium flow may be either substantially parallel or anti-parallel to the direction of light passing through the conduit. In some embodiments, the speed of the medium through the conduit is at least 0.000001 c, 0.00001 c, 0.001 c, 0.005 c, 0.01 c, 0.05 c, 0.1 c, or a range between any two of these values.

In other embodiments, the direction of flow of the medium through the conduit is oscillated back and forth, such that during a first period of time, the direction of flow of the medium is generally parallel to the direction of light passing through the conduit, and during a second period of time, the direction of flow of the medium is generally anti-parallel to the direction of light passing through the conduit. In some embodiments, the frequency of oscillation of the medium is at least 1 Hz, 100 Hz, 1 kHz, 5 kHz, 10 kHz, 50 kHz, 100 kHz, 500 kHz, 1 MHz, 5 MHz, 10 MHz, 50 MHz, 100 MHz, 500 MHz, 1 GHz, or a range between any two of these values. In some embodiments where the direction of flow of the medium is oscillated back and forth, the maximum speed of the medium during the oscillation is at least 0.000001 c, 0.00001 c, 0.001 c, 0.005 c, 0.01 c, 0.05 c, 0.1 c, or a range between any two of these values.

In one embodiment, the conduit includes coils configured to generate magnetic fields suitable for containing charged particles within the conduit. For example, the coils may include dipole, quadrapole, and/or higher-pole coils. In some embodiments, the coils are constructed from superconducting material and the conduit includes suitable cooling apparatus for maintaining the material in a superconducting state. In some such embodiments, the medium within the conduct is a plasma (e.g., a helium plasma). Accordingly, some embodiments include an ionizer for ionizing gas (e.g., helium gas) and introducing it into the conduit. Some embodiments include a linear accelerator for accelerating the ionized gas prior to introduction into the conduit. In some embodiments, the plasma within the conduit is oscillated back and forth by modulating the magnetic field coils.

### Principle of Operation

In his special theory of relativity, Einstein postulated that the laws of physics are equivalent in all inertial reference frames (“IRFs”), and that light travels in a vacuum at a constant speed regardless of reference frame [¹]. These postulates led to a number of remarkable findings with respect to time, space, momentum, and energy. The concepts of “time dilation” and “length contraction” are based on these two postulates [²].

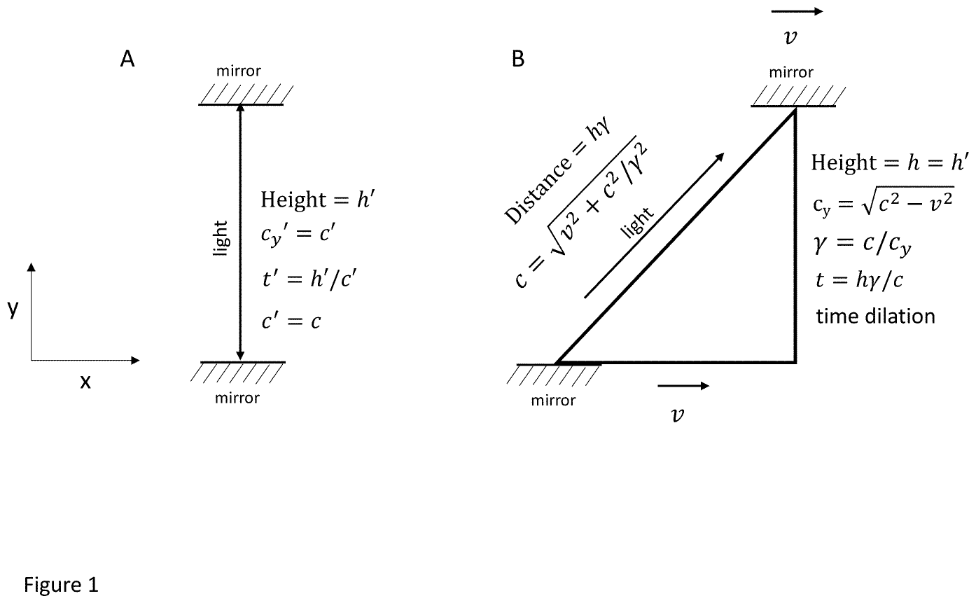

A well-known illustration of time dilation utilizes a thought experiment in which a light beam appears to travel between two parallel mirrors, along an axis that is 90 degrees to the direction of motion of an IRF moving at velocity v (FIG. 1). An observer within the moving IRF (Observer 1) will perceive light to be moving at a right angle to the direction of IRF motion. But an observer in a different IRF (Observer 0), will see the light beam traveling along a diagonal path [2]. FIG. 1 illustrates two perceived paths; where, according to Einstein's postulates, the diagonal speed of light must be equal to c, which is 299,792,458 meters per second in vacuum.

According to Einstein the y-component of light's velocity, c_{y} must equal \sqrt{c²−v²}, which must be less than c if v is not zero (FIG. 1B). Einstein utilized the Lorentz transformations to quantify the resulting impact on distance and speed [³]. The Lorentz transformations utilize a scaling factor represented by the symbol gamma,

$$y = \frac{1}{\sqrt{1 \frac{{v}^{2}}{{c}^{3}}}}$$

where v is the velocity of one inertial reference frame with respect to another reference frame, and c is the speed of light, both measured in meters per second. Note that if the numerator and denominator of the right side of the gamma equation are multiplied by c, the resulting quotient is equivalent to the ratio of the speed at which light is perceived to travel along the diagonal side of the right triangle in FIG. 1B, divided by the speed at which light is perceived to travel along its vertical side.

$$y = \frac{c}{\sqrt{{c}^{2} - {v}^{2}}}$$

The equation c_{y}=\sqrt{c²−v²} can be rewritten as

c_{y}=c/γ (1)

In essence, the Lorentz factor reflects the factor by which the speed of the moving IRF causes the y-component of light's velocity, as seen by Observer 0, to be less than c.

If time is kept by the periodic bouncing of light against the mirrors, Observe 0 will see the vertical component of Observer 1 's light traveling slower than light in a light clock in Observer 0's IRF, because Observer 0 will see Observer 1's light traveling diagonally, γ fold farther at speed c. Whereas the light in a light-clock in Observer 0's IRF will not (appear to Observer 0 to) travel diagonally. Observer 1 does not know that the y-component of light speed is γ fold slower than c, because Observer 1's clock is calibrated to the ticks of light hitting the mirrors, and so a second′ for Observer 1 (per convention, primes will be used to denote properties of the moving IRF as observed by Observer 1) has a γ fold longer duration than a second for Observer 0 (“time dilation”). When Observer 1 unknowingly divides the γ-fold longer diagonal distance by a γ-fold longer second′, Observer 1 computes the same speed of light as Observer 0.

If the mirrors in FIG. 1A are separated by h′ meters′, the time that elapses while light travels from mirror to mirror and back is

Δt′=2h′/c′ seconds′,

as measured in Observer 1's meters′ and meters′ per second′ [2].

Observer 0, on the other hand, will measure the duration of the round trip interval, to be

Δt=2h/c_{y}=2γh/c seconds (2)

as counted in Observer 0's seconds. Since Einstein believed that Δx′/Δt′meters′/second′=c′=Δx/Δt meters/second=c, and h′ transverse meters′=h transverse meters, Observer 0 will record a larger number of seconds (because gamma is always equal to or greater than 1) than the number of seconds′ recorded by Observer 1.

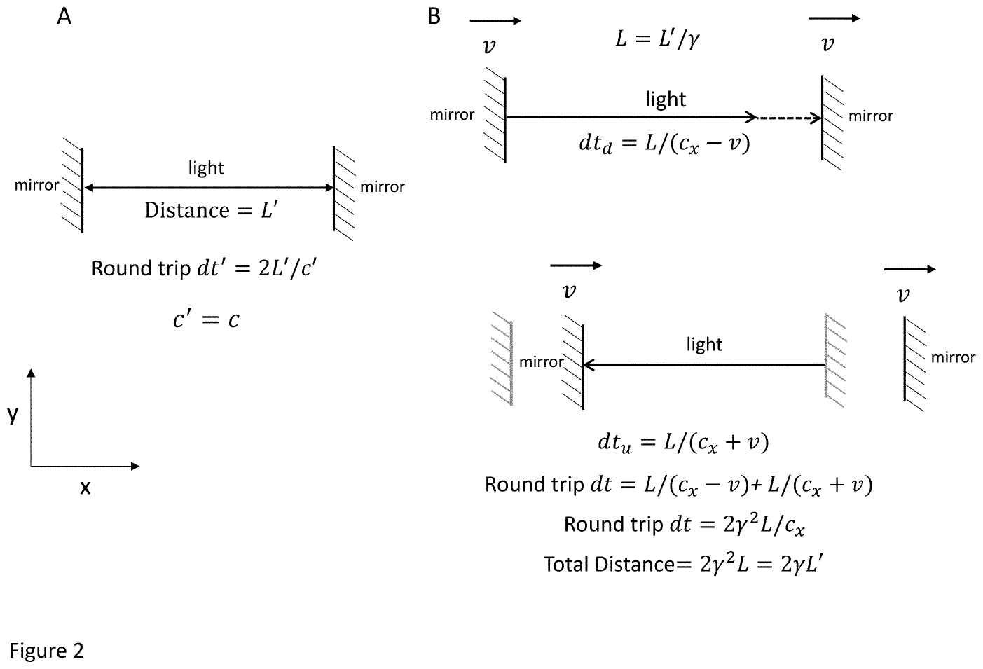

The situation becomes more complicated if light is bounced longitudinally within the moving IRF (FIG. 2). When light travels in the direction of the reference frame's motion, the “downstream” mirror recedes from the light. If we accept Einstein's postulate that light travels at a constant speed, c, regardless of the speed of the source of the light, then the relative speed at which Observer 0 measures light approaching the downstream mirror will be cₓ−v, where cₓ=c meters per second. When the reflected light returns “upstream”, its speed relative to the approaching upstream mirror will be cₓ+v meters per second. If the mirrors are separated by the static distance L′ meters′, then the length of time for light to travel from one mirror to the other and back should appear to Observer 1 to be

Δt′=2L′/c seconds′

But to Observer 0, who sees the different relative speeds (cₓ−v) and (cₓ+v),

$$Δ t = ( \frac{{L}^{′}}{{c}_{x} - v} + \frac{{L}^{′}}{{c}_{x} + v} )$$

which, if cₓ=c is equal to,

Δt=2γ²L′/c seconds (3)

provided that L′ meters′ are the same as L′ meters.

If the distance h′ between the mirrors in FIG. 1 is equal to the distance L′ between the mirrors in FIG. 2, h′=L′ meters′; and if the horizontal length between mirrors observed by Observer 0 is also L′ meters=L′ meters′, then the longitudinal travel time, as measured by Observer 0, would be predicted by Equation ((3) to be gamma times longer than the time required for light to travel the same distance in the transverse direction (Equation ((3) divided by Equation ((2)), provided that cₓ=c.

In 1887 Michelson and Morley published their famous experiment attempting to determine the speed at which the Earth was moving through a hypothetical “aether” [⁴]. They assumed that Equations ((2) and ((3) would yield different travel times for light moving in-line with the Earth's motion versus light moving perpendicular to Earth's motion. They found no difference, nor has anyone who has repeated the experiment with ever-greater precision since. Although Einstein later concluded that their experiment was destined to produce a null result in Earth's moving reference frame, he needed to explain how Observer 0 would also measure no difference between the time light travels along both arms of the Michelson Morley apparatus.

Lorentz, Fitzgerald, and Einstein (“LFE”) all concluded that lengths contract in the direction of the motion of an inertial reference frame, as observed by Observer 0 [1,3,⁵]. They conjectured that when dt=0 (simultaneous in Observer 0's frame), the distance between longitudinally placed mirrors would physically contract by a factor of gamma, and the contracted meters′ would equal a fewer number of uncontracted meters.

L_{c}=L′/γ meters

The time required for light to make the contracted longitudinal trip in Observer 0's frame would be,

$$Δ t = \frac{{L}_{c}}{{c}_{x} - v} + \frac{{L}_{c}}{{c}_{x} + v}$$

If cₓ=c then Equation ((3) can be rewritten as

Δt(length contracted)=(2γ²L_{c}/c)=2γL′/c (4)

seconds.

To be clear, an uncontracted meter′ is the same length as a meter, but a contracted meter′ is shorter than a meter by a factor of γ. L′ in Equation ((4) represents the original number of uncontracted meters′, whereas L_{c} represents the smaller number of meters that are equivalent in length to contracted meters′. And if L′ meters′(uncontracted)=h′=h, then the times for longitudinal and transverse light travel would be the same.

According to special relativity, the transverse (higher order) Doppler effect (“TDE”) reflects an actual reduction in the frequency emitted by a moving source (as detected in the stationary frame) compared to the frequency of the same source when stationary. This has been demonstrated experimentally in the longitudinal direction by Ives and Stilwell [⁶], Kaivola, et al [⁷], Grieser et al [⁸], and Botermann et al [⁹], and in the transverse direction by Chou, et al [23]. When light is transmitted from moving source to moving receiver within an IRF, the receiver's time dilation masks this higher-order reduction in frequency, since co-moving sources and receivers both measure frequency in the same gamma-fold, time dilated units of waves per second′. Since light speed equals wavelength times frequency, λf=c in special relativity, the actual reduction of frequency requires light either to travel slower, or wavelength to increase. Consistent with the transverse (higher order) Doppler effect, as demonstrated by Ives and Stilwell [6], wavelength increases gamma fold. This presents a concern in the moving frame. If emission wavelengths increase in the moving frame, observers in the moving IRF might see a higher order red shift from sources within their own IRF.

It is helpful to separate the primary and higher-order Doppler effects in this case. The primary Doppler compression of waves caused by a source moving parallel to the emitted light will be exactly reversed by a receiver moving at the same speed and in the same direction as the source. However, the higher order Doppler effect (TDE) will cause the source's emission frequency to be lower by a factor of γ_{L}, which will cause the emitted wave crests to be farther apart than otherwise. This would violate one of Einstein's postulates, that the laws of physics are the same regardless of the speed of the IRF. The LFE solution to this issue is length contraction between the source and receiver within the moving IRF. If lengths contract gamma fold between the source and receiver, then wavelengths will also contract gamma fold, and this will negate a longitudinal intra-IRF red shift. Thus, moving receivers would detect no red shift of longitudinal light coming from a source moving at the same velocity within the same IRF.

The very basic equation,

$${λ}_{0} \cdot {f}_{0} = c$$

could be written as,
for the moving IRF, to reflect the postulated compensations for a) intra-IRF red shift (compensated for by contracting wavelengths in the direction of motion) and b) moving emitter frequency reduction (compensated for by time dilation of the moving receiver).

The Lorentz transformations and Einstein's special theory of relativity are built upon the assumption that longitudinal light traveling within a moving IRF moves between contracted distances, and thus will exhibit contracted wavelengths to Observer 0. This concept of longitudinal length contraction of wavelengths means that everything between every intra-IRF source-receiver pair: every cloud, planet, star, and galaxy must physically contract in the LFE model, potentially over distances of billions of light years. If true, this must happen for billions of source-receiver pairs in concert. And when non-colinear IRFs intersect, then objects within the intersecting region must contract in more than one dimension simultaneously. Additionally, after one IRF passes through another IRF, objects that were once within the intersection must re-inflate as the IRFs disentangle, and re-contract when other IRFs pass through.

The LFE contraction, if it is real, cannot merely be an illusion or virtual effect. Length contraction is not the same as the Terrell effect, which has to do with the time required for light to travel from an object to a distant observer [¹⁰]. According to the Lorentz transformation for Δx′, when Δt=0 (simultaneous events in Observer 0's frame) Δx′=γΔx, which means that Δx=Δx′/γ. Which means that the physical distance separating simultaneous events in Observer 0's frame, such as for example the firing of paintballs downward from the front and back of a moving train of proper length Δx′ uncontracted meters, will result in actual paint marks on the tracks Δx′/γ meters apart. The distance between the marks will be shorter than the train length at rest. The Lorentz transformations do not provide room for an inattentive Observer 0 to believe that non-simultaneous events occur simultaneously. The Lorentz transformations refer to when events occur in the relevant frame, not when they are perceived to occur. Therefore, if the Lorentz transformations provide a true description of reality, then lengths, including wavelengths and intra-IRF source-receiver distances, must physically contract, in real time, changing constantly in different dimensions as myriad source-receiver pairs cross paths.

Attempts to measure length contraction have been less than conclusive [¹¹,¹²,¹³,¹⁴]. Various paradoxes have been put forth to examine the validity of length contraction [¹⁵,¹⁶,¹⁷,¹⁸]. Rotating objects that are contracted along one axis must re-expand, and then contract along a different axis during rotation relative to the direction of motion. Little has been published to examine the inevitable impact on intramolecular and subatomic forces and energies that would result from length contraction. Rigid materials would have to contract as easily and quickly as compressible materials. The energy and thermodynamic implications of length contraction and re-expansion, especially over billions of light years, has not been adequately explained. Yet, likely because a viable alternative has not been put forth, the concept has generally been accepted.

Fortunately, the result of the Michelson Morley experiment, and other tests of special relativity, can be explained in other ways. One trivial alternative would be “length expansion” in the direction perpendicular to the motion of the reference frame. But this alternative raises objections similar to those raised by length contraction. Another explanation would be an anisotropic effect of motion on time. For example, time dilation could occur in the longitudinal direction, but not perpendicular to it. Or time contraction could occur perpendicular to the direction of motion, but not longitudinally. However, there is substantial evidence for time dilation in rough proportion to y in GPS satellite clock systems [¹⁹], and there have been no reports of non-isotropic time dilation to date.

Another alternative to length contraction would challenge one of Einstein's fundamental postulates: the constancy of the speed of light in space. If light traveled at a different speed longitudinally versus transversely, as perceived by Observer 0, the Michelson Morley result could be explained without length contraction. For example, if light traveled c/γ in the transverse direction, Observer 0 would measure the time of travel to be same in both arms of the Michelson Morley apparatus. Unfortunately, this solution would require the y-component of light, c_{y} in FIG. 1B, to travel at c/γ² instead of the c/γ speed predicted by special relativity. This would cause time dilation to be proportional to γ² instead of γ, which would not be consistent with experimental evidence related to time dilation.

Another alternative is for light to travel at speed c transverse to the direction of IRF motion, and a factor of “gamma” faster in the direction of IRF motion. The present paper analyzes this possibility.

Postulates

For purposes of the present disclosure, the relationships between distance, time, speed, mass, and energy can be elucidated with the following postulates:
(1) Time measurements will be dilated in an inertial reference frame moving at speed β=v/c by a factor of γ₂=\sqrt{1+β²}.
(2) As measured from a stationary frame, the speed of light emitted from an inertial reference frame moving at speed β=v/c will be γ_{φ}·c=\sqrt{(1+β²)/(1+β² sin²φ)}·c meters per second, where the angle φ is the direction of light-travel measured with respect to the direction of motion of the moving inertial reference frame.

The Alternative Model

Assume a universe where meter sticks are the same length as in Einstein's universe but do not contract. Since the mathematical relationships in the longitudinal Lorentz transformations assume length contraction, the alternative model assumes that the Lorentz time-dilation factor γₜ is here replaced with γₛ, the Lorentz length contraction factor γₗ is replaced with γ_{φ}, Δx′ is replaced with γ_{φ}Δx′ to reverse the assumption of length contraction in Lorentz's transformations (Lorentz and Einstein used the symbol γ to mean different things in different equations. γ either means meters/contracted meters′ or seconds/seconds′ (shown as γₗ and γₜ respectively) or contracted meters′/meter or seconds′/second (shown as γ_{l′} and γ_{t′} respectively) to convert between frames. In the alternative transformations, with no length contraction, the conversion between observed travel distance in the moving versus stationary frames is a unitless γ_{φ}²; and γₛ denotes the velocity-dependent time dilation function that converts seconds′ in the moving frame to seconds in the stationary frame.), and the speed of light in the longitudinal direction is labeled cₓ.

| Lorentz | Alternative (first step) |
|---|---|
| Δx = γ [symbol] Δx [symbol] + γₜΔdt [symbol] | Δx = γ_{ϕ}²Δx [symbol] + γ [symbol] vΔt [symbol] |
| Δt = γₜΔt [symbol] + γ [symbol] vΔx [symbol] /c² | Δt = γ [symbol] Δt [symbol] + γ_{ϕ}²vΔx [symbol] /cₓ² |
| Δx [symbol] = γᵥΔx − γᵥvΔt | y_{ϕ}Δx [symbol] = y_{ϕ}Δx − y_{ϕ}vΔt |
| Δt [symbol] = γ [symbol] Δt − γ [symbol] vΔx/c² | Δt [symbol] = γ [symbol] Δt − γ_{ϕ}vΔx/cₓ² |

[symbol]

indicates data missing or illegible when filed

When Δx′=0, events occur at the same location within a moving IRF. The alternative Δt transformation then becomes Δt=γ_{c}Δt′, revealing that, as in the original Lorentz transformations, the tempo of time at a single location within a moving IRF is different than in a relatively stationary IRF (the formula for γₛ will be derived below).

Equation ((2) shows Δt for a “round trip”. For the one-way trip in the alternative model, Equation ((2) is divided by 2 and γ is replaced with γₛ.

$$Δ t = \frac{{y}_{s} h}{c} .$$

In agreement with special relativity (and with the absence of length contraction in any dimension), Δy′=Δy, which in this example means that h′=h. Therefore,

$$\frac{Δ y}{Δ t} = \frac{hc}{{y}_{s} h} = \frac{c}{{y}_{s}} .$$

As observed from the stationary frame, the y-component of light speed for light that originated within a moving IRF is c/γₛ.

Since Δy′=Δy and h′=h, the equation above becomes,

Δy′/Δt=h′c/γₛh=c/γₛ

And since Δt=γₛΔt′ when Δx′=0,

$$\frac{Δ {y}^{′}}{Δ {t}^{′}} = \frac{Δ {y}^{′}}{Δ t / {y}_{s}} = {y}_{s} c / {y}_{s} = c$$

confirming that light speed in the y direction for light that originated within a moving IRF as observed from within the moving IRF is equal to c. The same would be true in the z direction.

Since the Lorentz length-contraction and time-dilation factors are equivalent, it will be assumed for the moment (and confirmed below) that the same is true for motion in the longitudinal direction in the alternative model,

γ_{φ}(logitudinal)=γₛ

If the alternative Δx transformation is divided by the Δt transformation, the numerator and denominator divided by Δt′, and Δx′/Δt′ replaced with c (an assumption that will be proved below), an expression is obtained for Δx/Δt,

$$\frac{Δ x}{Δ t} = \frac{{y}_{ϕ}^{2} c + {y}_{s} v}{{y}_{s} + {y}_{ϕ}^{2} vc / {c}_{x}^{2}}$$

Renaming Δx/Δt as cₓ, equating with γ_{φ} and γₛ, rearranging,

$${y}_{s} {c}_{x} + \frac{{y}_{s}^{2} vc}{{c}_{x}} = {y}_{s}^{2} c + {y}_{s} v$$

Solving for cₓ yields

cₓ=γₛc,

That is, longitudinal light speed as observed from a “stationary” frame is scaled in proportion to the alternative gamma factor γₛ.

γₛ can be derived by computing round trip Δt with respect to γₛc and v.

$$Δ t = \frac{{L}^{′}}{{y}_{s} c - v} + \frac{{L}^{′}}{{y}_{s} c + v} = \frac{2 {y}_{s} c {L}^{′}}{{y}_{s}^{2} {c}^{2} - {v}^{2}} \qquad ( 6 )$$

Since the Michelson Morley result must also hold true in the alternative model, the value for Δt must be consistent with Equations ((2) and ((4) when γ is replaced with γₛ.

$$\frac{2 {y}_{s} c {L}^{′}}{{y}_{s}^{2} {c}^{2} - {v}^{2}} = \frac{2 {y}_{s} {L}^{′}}{c} \\ c / ( {y}_{s}^{2} {c}^{2} - {v}^{2} ) = 1 / c \\ {c}^{2} = {y}_{s}^{2} {c}^{2} - {v}^{2} \\ {y}_{s}^{2} = ( {c}^{2} + {v}^{2} ) / {c}^{2} = 1 + {v}^{2} / {c}^{2} \\ {y}_{s} = \sqrt{1 + {v}^{2} / {c}^{2}} \qquad ( 7 )$$

The validity of Equation ((7) is supported by substituting cₓ for c in the equation for Lorentz's γ,

$${y}_{s} = \frac{1}{\sqrt{1 - \frac{{v}^{2}}{{c}_{x}^{2}}}}$$

By squaring both sides of cₓ=γₛc

$${c}_{x}^{2} = \frac{{c}^{2}}{1 - \frac{{v}^{2}}{{c}_{x}^{2}}}$$

$${c}_{x}^{2} - {v}^{2} = {c}^{2}$$

$${c}_{x} = \sqrt{{c}^{2} + {v}^{2}} = c \sqrt{1 + {v}^{2} / {c}^{2}} = {cy}_{s}$$

$${y}_{s} = \sqrt{1 + {v}^{2} / {c}^{2}}$$

The speed of light emitted longitudinally from a moving source is γₛc in a universe with no length contraction. In such a universe, motion causes longitudinal light speed to increase by γₛ and time to dilate by γₛ. Interestingly, γₛ grows from 1, when v=0, to a number larger than 1 with no upper bound, even when the absolute value of v exceeds c. Clocks continue to slow as v increases, and speeds and frequencies, as expressed in time-dilated meters/second′, continue to increase. Lorentz's γ tends toward infinity as v approached c. That necessarily follows from the assumption that motion causes length contraction. Without that assumption, superluminal speeds are not prohibited.

The expressions in Equations ((2), ((3), and ((4), restated using γₛ, become

$$Δ t = \frac{2 γ {\text{?}}^{2} L}{{c}_{x}} = \frac{2 γ {\text{?}}^{2} L}{γ \text{?} c} = \frac{2 γ \text{?} L}{c} = \frac{2 γ \text{?} {L}^{′}}{c} = \frac{2 γ \text{?} {h}^{′}}{c} = \frac{2 γ \text{?} h}{c}$$

$$\text{?} \text{indicates text missing or illegible when filed}$$

thereby reconciling the Michelson Morley result in all frames without length contraction.

The last ratio might be interpreted to imply that, from the stationary perspective, if light is aimed so that it strikes a target lying orthogonal to but co-moving with the light's source, it will travel a round trip distance of 2γₛh at speed c. Actually, the one-way diagonal distance (as seen from the stationary frame) that light travels when aimed so that it strikes the orthogonally positioned, co-moving target is,

diagonal distance=\sqrt{h²+v²γₛ²dt′²}

and the speed at which light travels to the co-moving target (dx′=0 when co-moving), from the perspective of the stationary frame is,

$${c}_{diagonal} = \frac{diagonal distance}{dt} = \sqrt{\frac{{h}^{2}}{Δ {t}^{2}} + {v}^{2}} = \sqrt{\frac{{c}^{2}}{{γ}_{s}^{2}} + {v}^{2}} \qquad ( 8 )$$

Dividing diagonal distance by c_{diagonal} yields Δt, which is the same time as in the restated Equations (2), (3), and (4) above. Expressed differently, the details behind the Michelson Morley result are revealed in,

$$Δ t = Δ {t}_{diagonal} = Δ {t}_{longitudinal} = Δ {t}_{transverse}$$

$$Δ t = \frac{\sqrt{{h}^{2} + {v}^{2} {γ}_{s}^{2} {dt}^{′2}}}{\sqrt{\frac{{c}^{2}}{{γ}_{s}^{2}} + {v}^{2}}} = \frac{{γ}_{s}^{2} L}{{γ}_{s} c} = \frac{{γ}_{s} h}{c}$$

The expression for c_{diagonal} contains the y-component of light speed as seen from the stationary frame, c/γₛ, when the light is aimed orthogonally at a co-moving target from the perspective of the moving IRF (c_{y}=c/γₛ), and the x-component of light speed, v. For confirmation, since the Michelson Morley result must hold in all IRFs, round trip travel time in the x and y directions must be equal. Therefore if L=h, then h divided by the y-component of light speed must equal the longitudinal distance, γₛ²L, divided by longitudinal light speed, γₛc.

$$\frac{2 {γ}_{s}^{2} L}{{γ}_{s} c} = 2 h / {c}_{y}$$

After substitutions,

$${c}_{y} ( the y component of light speed = Δ y / Δ t ) = \frac{hc γ \text{?}}{γ \text{?} L} = \frac{c}{γ \text{?}}$$

$$\text{?} \text{indicates text missing or illegible when filed}$$

When v=0, γₛ=1, and the y-component of light speed equals c. To be clear, when light is aimed 90 degrees from the direction of IRF motion, where the angle is measured from the stationary perspective, the light will travel at speed c; but when light is aimed 90 degrees from the direction of IRF motion, where the angle is measured by observers in the moving IRF, the light will travel at an angle different from 90 degrees from the perspective of observers in the stationary frame,

$${ϕ}^{′} = arctan ( \frac{h}{vdt} )$$

Its speed will be c_{diagonal} meters per second, and the y-component of its speed will be c/γₛ meters per second.

The equation for c_{diagonal} can be rewritten as,

$${c}_{diagonal} = c \sqrt{\frac{1}{{γ}_{s}^{2}} + \frac{{v}^{2}}{{c}^{2}}} = c \sqrt{\frac{1 + {β}^{2} + {β}^{4}}{1 + {β}^{2}}} ,$$

where β=v/c.

When c_{diagonal} is plotted as a function of v it traces an elliptical pattern. The distance that light travels in Δt seconds for any value of v can be computed with the equation for an ellipse,

$$\frac{{x}^{2}}{γ \text{?}} + {y}^{2} = {c}^{2} Δ {t}^{2}$$

$$\text{?} \text{indicates text missing or illegible when filed}$$

When v=0, then γₛ=1 and the equation resolves to the equation for a circle with radius c²Δt.

In three dimensions, when v=0, light waves travel in concentric spheres. But when v≠0, the waves form an ellipsoid with y,z symmetry around the x-axis (where the x-axis is the direction of IRF motion), of the form

$$\frac{{x}^{2}}{{γ}_{s}^{2}} + {y}^{2} + {z}^{2} = {c}^{2} Δ {t}^{2}$$

Or, loosely analogous to the space-time interval of special relativity,

$${c}^{2} Δ {t}^{2} - \frac{{x}^{2}}{γ \text{?}} + {y}^{2} + {z}^{2} = {s}^{2}$$

$$\text{?} \text{indicates text missing or illegible when filed}$$

If y=z, and s=0, then

$$y = z = \sqrt{\frac{{c}^{2} Δ {t}^{2} - {x}^{2} / γ \text{?}}{2}}$$

$$\text{?} \text{indicates text missing or illegible when filed}$$

When y and z are zero, x and −x are at their maximum and minimum, respectively. When x=0, y and z are at their maxima.

In polar coordinates, the radius of an ellipse can be computed with,

$${r}_{ellipse} = \frac{ab}{\sqrt{{a}^{2} {sin}^{2} ϕ + {b}^{2} {cos}^{2} ϕ}} ,$$

where a represents the major axis, which here would be γₛcΔt, and b represents the minor axis, which here would be cΔt. This produces the equation,

$${r}_{ellipse} = \frac{{γ}_{s} c Δ tc Δ t}{\sqrt{{( {γ}_{s} c Δ t )}^{2} {sin}^{2} ϕ + {( c Δ t )}^{2} {cos}^{2} ϕ}}$$

Factoring cΔt from numerator and denominator,

$${r}_{ellipse} = \frac{γ \text{?}}{\sqrt{γ \text{?} {sin}^{2} ϕ + {cos}^{2} ϕ}} c Δ t = \frac{\sqrt{1 + {v}^{2} / {c}^{2}}}{\sqrt{1 + {v}^{2} {sin}^{2} ϕ / {c}^{2}}} c Δ t$$

$$\text{?} \text{indicates text missing or illegible when filed}$$

In general, the wave pattern of light (in two dimensions) coming from a moving source is in the shape of an ellipsoid (ellipse) described (in two dimensions) by,

$${γ}_{ϕ} c Δ t = \sqrt{\frac{1 + {β}^{2}}{1 + {β}^{2} {sin}^{2} ϕ}} c Δ t$$

where φ is the angle between the direction of the moving source and the direction of light emitted from the source. For any given value of v, light travels at its greatest speed in the longitudinal direction (sin φ=0 and γ_{φ}=γₛ). When sin φ=1 light travels at speed c in the transverse direction.

When the alternative Δx′ transformation is divided by the Δt′ transformation, an expression is obtained for light speed in the x-direction within the moving IRF,

$$\frac{Δ {x}^{′}}{Δ {t}^{′}} = \frac{Δ x - vdt}{{γ}_{z} dt - \frac{{γ}_{s} v Δ x}{{γ}_{z}^{2} {c}^{2}}}$$

When numerator and denominator are divided by Δt,

$$\frac{Δ {x}^{′}}{Δ {t}^{′}} = \frac{{γ}_{s} c - v}{{γ}_{z} - \frac{v}{c}} = \frac{c ( {γ}_{s} - \frac{v}{c} )}{{γ}_{s} - \frac{v}{c}} = c$$

confirming that the alternative transformations are consistent with an observer in the moving IRF measuring light to be traveling at speed C in the x-direction (as well as in the y and z directions).

Thus the alternative transformations describe a universe that is consistent with our Earth-bound observations (light travels at speed c in all directions) and with the result of the Michelson Morley experiment. Light emitted by a stationary source also travels at speed in the stationary frame (γ_{φ}=1), but can be perceived to travel at γₛc meters per second′ by a moving observer due to dilation of the observer's clock. It is only light emitted by a moving source as observed from a stationary frame that travels at γ_{φ}c, a difference that would be imperceptible except for sources moving very rapidly toward or away from a stationary observer.

Relativistic Doppler Effect

Einstein predicted that the frequency of light emitted by a moving source would decrease in proportion to the slowing of the source's “clock” [²⁰]. This is the transverse Doppler effect. Champeney et al performed a Mossbauer experiment [²¹] showing that a stationary receiver will detect a lower frequency when light comes from a moving source versus from a stationary source, supporting Einstein's prediction (In special relativity, when reference is made to a “stationary frame”, the frame can be any reference frame deemed to be stationary. However the concept of an arbitrary stationary frame is problematic, even for special relativity. The alternative model assumes that the stationary frame is a unique frame, such as the frame of the cosmic microwave background radiation “CMBR”).

To be clear, a moving source will emit light at a frequency that is γ-fold lower as measured in a stationary observer's waves per second (fᵣ=fₛ′/γ waves per second) (²²). On the other hand, observers in the frame of the moving source will detect fₛ′=f₀ waves for every one of their time-dilated moving seconds′.

Champeney et al (21) and Chou (²³) also showed that a receiver moving with respect to a source (and with respect to the laboratory) will measure a higher frequency as compared to when the source and receiver are stationary.

Einstein modified the classical Doppler equations for a moving receiver and a stationary source, and for a moving source and a stationary receiver, compensating each moving object for time dilation, and thereby derived two equations for the relativistic Doppler effect [20].

$$\begin{matrix}{f}_{r}^{′} = {f}_{0} {γ}_{L} ( 1 + \frac{v}{c} cos ϕ ) . \\ and & ( 9 ) \\ {f}_{r} = \frac{{f}_{0}^{′}}{{γ}_{L} ( 1 - \frac{v}{c} cos ϕ )} , & ( 10 )\end{matrix}$$

where, fᵣ′ is the frequency observed by a receiver that is moving with respect to a reference observer (expressed in waves per time-dilated second′); fᵣ is the frequency observed by a receiver that is stationary within the frame of a reference observer (expressed in waves per stationary-frame second); f₀ is the emission frequency coming from a source that is stationary in the frame of a reference observer (expressed in waves per second) and f₀′ is the emission frequency coming from a source that is moving with respect to the frame of a reference observer (expressed in waves per time-dilated seconds′); γ_{L}=1/\sqrt{1−v²/c²} is the Lorentz factor; v is the speed of the source in the frame of the reference observer (expressed in meters per second) where a positive velocity represents one element (source or receiver) moving toward the other element (Einstein used a minus sign in equation reflecting his definition of velocity, which is positive when an element moves in the direction of the positive x-axis. The present treatment uses the Doppler convention where velocity is positive when one object moves closer to the other object.); c is light speed expressed in meters per second, and φ is the angle between the line connecting the source to the receiver at the instant of observation, as compared to the direction of motion of the moving element (receiver or source).

These equations can be combined to produce,

$${f}_{r}^{′} = {f}_{s}^{′} \frac{{γ}_{L , r} ( 1 + \frac{{v}_{r} cos {ϕ}_{r}}{c} )}{{γ}_{L , s} ( 1 - \frac{{v}_{s} cos {ϕ}_{s}}{c} )} \qquad ( 11 )$$

where vₛ is the speed of the source, vᵣ is the speed of the receiver, γ_{L,s} is the Lorentz factor computed using the speed of the source traveling in any direction through the (stationary) frame, γ_{L,r} is the Lorentz factor computed using the speed of the receiver traveling in any direction through the (stationary) frame, φᵣ is the angle between the direction of receiver motion and the line connecting the source at the moment it emits light to the receiver at the moment of detection, and φₛ is the angle between the direction of source motion and the line connecting the source at the moment it emits light to the receiver at the moment of detection.

It can be shown that Equation (11) is consistent with the commonly used forms of the relativistic Doppler equation when the motion of the source and receiver are purely longitudinal, by setting cos φ to 1, and vₛ or vᵣ to zero. When vₛ=0, the frequency observed by a moving receiver measured in waves per second′ (The source and receiver must be moving directly toward or away from each other in order for the commonly used form of the relativistic Doppler equation to be valid. If either moves at an angle to the light transmission, then the (1+v/c) term is replaced with (1+v cos φ/c) and the formulas cannot be reduced to a simple ratio of square roots.) is,

$${f}_{r}^{′} = {f}_{0} {γ}_{L , r} ( 1 + \frac{{v}_{r}}{c} ) = \frac{{f}_{0} ( 1 + \frac{{v}_{r}}{c} )}{\sqrt{1 - \frac{{v}_{r}^{2}}{{c}^{2}}}} = {f}_{0} \frac{\sqrt{1 + \frac{{v}_{r}}{c}}}{\sqrt{1 - \frac{{v}_{r}}{c}}}$$

Likewise, when is set to zero, the frequency observed by the stationary receiver, in waves per second, is,

$${f}_{r} = ( {f}_{s}^{′} / {γ}_{L , s} ) \frac{1}{1 - \frac{{v}_{s}}{c}} = {f}_{0} \frac{\sqrt{1 + \frac{{v}_{s}}{c}}}{\sqrt{1 - \frac{{v}_{s}}{c}}}$$

Although these equations would appear to be equal when vᵣ=v and vₛ=0 as compared to when vₛ=v and vᵣ=0, they differ by the units by which frequency is measured, fᵣ′ being measured in waves per second′, and fᵣ being measured in waves per second with respect to the clock of a stationary reference observer. This difference in units is caused by the difference in clock rates in the respective inertial reference frames. A stationary observer would not agree that fᵣ′ and fᵣ are the same; but to local observers measuring frequency with their own clocks, the frequencies are numerically equivalent.

If a source moves transversely (cos φ=0) with respect to a receiver that is stationary in the frame of a stationary reference observer, γ_{L,r} will equal 1. Therefore,

$${f}_{r} = \frac{{f}_{s}^{′}}{{γ}_{L , s}} = \frac{{f}_{0} ( numerically )}{{γ}_{L , s}}$$

Since the receiver is not moving relative to the reference observer, the prime is removed from the fᵣ frequency term and expressed in waves per stationary observer seconds.

If the source resides in the frame of the reference observer and the receiver moves transversely, the source's clock will “beat” in stationary seconds. If the receiver were to perceive the light to strike at a right angle, the frequency measured by the moving receiver will be

fᵣ′=γ_{L,r}fₛ=γ_{L,r′}f₀

The dimensions here are waves per receiver seconds′.

This would appear to present a challenge to the principal of relativity, since the receiver should detect the same frequency whether the receiver or the source is considered to be the moving object. However, Einstein invoked the aberration of light as an explanation for the apparent contradiction [1,20]. In the case where the moving receiver reaches the geometric point of closest approach, the receiver's speed adds a component of relative velocity to the light's total velocity. The light's velocity with respect to the moving receiver is a combination of the velocity c, coming from the source at a right angle to the receiver in the source's frame, and a relative velocity longitudinal to the receiver's motion caused by the receiver approaching the light as the receiver passes the geometric point of closest approach. From the receiver's reference frame, the combination of velocities causes the light to appear to approach the receiver at an aberration angle, which can be computed with,

$$cos {ϕ}_{r} = ( cos {ϕ}_{s} - \frac{v}{c} ) / ( 1 - \frac{v}{c} cos {ϕ}_{s} )$$

In the case where light approaches from a geometric right angle (cos φₛ=0), the receiver perceives the light to be approaching at cos φᵣ=−v/c. According to the principal of relativity, if the receiver were not moving and the source were moving at speed r/c such that the source's light approached the receiver at an angle yielding cos φᵣ=−v/c, the receiver would detect a frequency of,

$${f}_{r} = \frac{{f}_{s}^{′}}{{γ}_{r} ( 1 + \frac{v}{c} cos {ϕ}_{r} )} = {f}_{s}^{′} \frac{\sqrt{1 - \frac{{v}^{2}}{{c}^{2}}}}{1 - \frac{{v}^{2}}{{c}^{2}}} = {f}_{s}^{′} {γ}_{r}$$

In other words, the receiver expects that light approaching at angle φᵣ=arccos(−v/c) will have a frequency of fₛ′γᵣ, and not frequency fₛ′/γᵣ; the latter being the frequency expected if the receiver were to perceive light to approach at a right angle.

In the case where a moving receiver perceives the light to approach at a right angle (cos φᵣ=0), the cosine of the angle as seen by an observer in the frame of a stationary source will be,

$$cos {ϕ}_{s} = \frac{cos {ϕ}_{r} - \frac{v}{c}}{1 - \frac{v}{c} cos {ϕ}_{r}} ,$$

which is equal to −v/c. The frequency of light approaching a moving receiver at angle φₛ, the angle being measured in the frame of a stationary source, would be,

$${f}_{r}^{′} = {f}_{s} {γ}_{r} ( 1 + \frac{v}{c} cos {ϕ}_{s} ) = \frac{{f}_{s} ( 1 - \frac{{v}^{2}}{{c}^{2}} )}{\sqrt{1 - \frac{{v}^{2}}{{c}^{2}}}} = \frac{{f}_{s}}{{γ}_{r}}$$

waves per second′. This then explains how a moving receiver that perceives light to be approaching at a right angle will detect a frequency of fₛ/γᵣ waves per second′, while a moving receiver that is struck by light at the geometric point of closest approach (cos φ=0 and cos φ′=−v/c) will detect a frequency of fₛγᵣ waves per second′.

Nevertheless, there remain conflicts between special relativity and the relativistic Doppler effect. Einstein's relativistic Doppler equations approximate the Doppler effect by assuming that the source is “very far from the origin of coordinates” [1]. Einstein defined the angle θ as “ . . . the connecting line ‘source-observer’ makes the angle φ with the velocity of the observer . . . ”. He did not specify whether the “connecting line” is drawn at the instant of emission, the instant of observation, or otherwise. The “connecting line” and the associated angles change between the instant of emission and the instant of observation, and therefore this is an ambiguous definition. The Doppler effect is influenced by the angle between the velocity of the source and the direction of light at the instant of emission, and/or by the angle between the velocity of the receiver and the direction of light at the instant of observation. But the Doppler equation for a moving source yields an aberrant wavelength distribution when plotted against the angle at the instant of emission. Instead, the distribution approaches what is expected if the moving-source Doppler equation is computed using the angle between the source and receiver at the moment the receiver detects the light, but plotted against the angle at the instant of emission.

For another example of the conflicts accompanying special relativity theory, when φ=0=φ′, a moving receiver will detect frequencies of

$${γ}_{L , r} {f}_{0} ( 1 \pm \frac{v}{c} )$$

and wavelengths of

$${λ}_{0} / ( {γ}_{L , r} ( 1 \pm \frac{v}{c} ) )$$

between the receiver and a stationary source. In contrast, according to the classical Doppler effect, wavelength is determined by the equation,

$${λ}_{r} ( classical ) = \frac{{λ}_{0}}{1 \pm \frac{v}{c}} .$$

The average wavelength experienced by two moving receivers encountering the source's light in either the parallel or antiparallel direction is,

$${λ}_{r}^{′} ( average , special relativity ) = 0.5 ( \frac{{λ}_{0}}{{γ}_{L , r} ( 1 + \frac{v}{c} )} + \frac{{λ}_{0}}{{γ}_{L , r} ( 1 - \frac{v}{c} )} ) = {γ}_{L , r} {λ}_{0}$$

$${λ}_{r}^{′} ( average , classical ) = 0.5 ( \frac{{λ}_{0}}{( 1 + \frac{v}{c} )} + \frac{{λ}_{0}}{( 1 - \frac{v}{c} )} ) = {γ}_{L , r}^{2} {λ}_{0}$$

According to special relativity, the average wavelength of light will be gamma-fold shorter than that predicted by the classical Doppler equation.

The same result is attained by using the Lorentz transformation for average longitudinal distance traveled by light relative to two flanking receivers that are moving parallel and antiparallel to the light's direction,

Δx=0.5(γₗΔx′+γₜΔdt′+γₗΔx′−γₜΔdt′)=γₗΔx′

instead of the classical distance traveled γₗ²Δx′. According to the Lorentz transformations, the distance Δx is the distance light travels longitudinally in the stationary frame, and represents a physical contraction of length between the moving receivers. Since the Michelson-Morley result requires the round trip time for light to travel in the longitudinal (upstream+downstream) and transverse (distally+proximally) directions to be equal, special relativity requires the longitudinal contraction in both inertial reference frames (but only noticeable from the stationary frame, since the measuring standards in the moving frame are also contracted). Such length contraction applies to wavelengths between receivers as well as to the distance between receivers, thus causing wavelengths to be a factor of gamma shorter than that predicted by the classical Doppler effect.

If a stationary source is flanked by two pairs of receivers moving along the same axis longitudinally with respect to the source, and at time t=0 the receivers of the more proximal pair travel at speed v₁ as measured in the frame of the source, while the receivers of the more distal pair travel at speed v₂ as measured in the frame of the source, the speed of each pair will cause the distance between each pair to contract differentially by their respective Lorentz factors. Thus the two pairs will encounter an impossible conflict with respect to the distances between the pairs, since the speed of the distal pair will force the proximal pair to contract according to the speed of the distal pair while the speed of the proximal pair will cause it to contract according its own speed. Since the speeds of the pairs are both measured with respect to the stationary source, the speeds are not additive, either classically or relativistically. Any compound length-contraction of intervals within the region would cause the intra-pair distances to be other than that predicted by the Lorentz transformations, thereby distorting the wavelengths, frequencies, and speed of light between the pairs. If this were the case, and somehow source-receiver pairs were subject to some type of “entanglement”, it would have to be true for all overlapping inertial reference frames comprising sets of receivers traveling at different speeds, creating myriad conflicts for the special theory of relativity. For example, the color of light on the Earth would have to change continuously as the Earth rotates within other inertial reference frames requiring length contraction according to their relative velocities. But this does not happen.

The concept of length contraction is thus hopelessly unworkable.

Doppler Effects in the Alternative Model

In the alternative model a source that is stationary will emit light at a wavelength of λ_{Q} meters per wave, at a frequency of f₀ waves per second, and at a speed of c=λ₀f₀ meters per second (γₛ=1 and γₛc=c). And a source that is moving will emit at a wavelength of meters γ_{φ}γₛλ₀ per wave, at a frequency of f₀/γₛ waves per second, and at a speed of γ_{φ}λ₀f₀=γ_{φ}c meters per second.

The alternative model does not require wavelength contraction, because it does not require light to travel at speed c in all directions in all reference frames. The alternative model accepts that a moving receiver will measure the speed of light to be gamma fold faster when measured in time-dilated meters per second′, and that moving sources emit light in an ellipsoidal pattern.

If the alternative model were to simply use an analog to Equation (11), it would be,

$${f}_{r}^{′} = {f}_{s}^{′} \frac{{γ}_{s , r} ( 1 + \frac{{v}_{r} cos {ϕ}_{r}}{{γ}_{ϕ} c} )}{{γ}_{s , s} ( 1 - \frac{{v}_{s} cos {ϕ}_{s}}{{γ}_{ϕ} c} )} \\ Here \\ {γ}_{s , r} = \sqrt{1 + {v}_{r}^{2} / {c}^{2}} , \\ {γ}_{s , s} = \sqrt{1 + {v}_{s}^{2} / {c}^{2}} , \\ {γ}_{ϕ} = \sqrt{1 + {v}_{s}^{2} / {c}^{2}} / \sqrt{1 + {v}_{s}^{2} {sin}^{2} {ϕ}_{s} / {c}^{2}} , \\ and \\ cos {ϕ}_{r} = \frac{cos {ϕ}_{s} - \frac{{v}_{r}}{c}}{1 - \frac{{v}_{r}}{c} cos {ϕ}_{s}} . \qquad ( 12 )$$

However, while Equation (12) does not suffer from the conflicts presented by length contraction, it is still but an approximation, valid when the source and receiver are far apart. A more careful analysis can be used to derive a more precise equation.

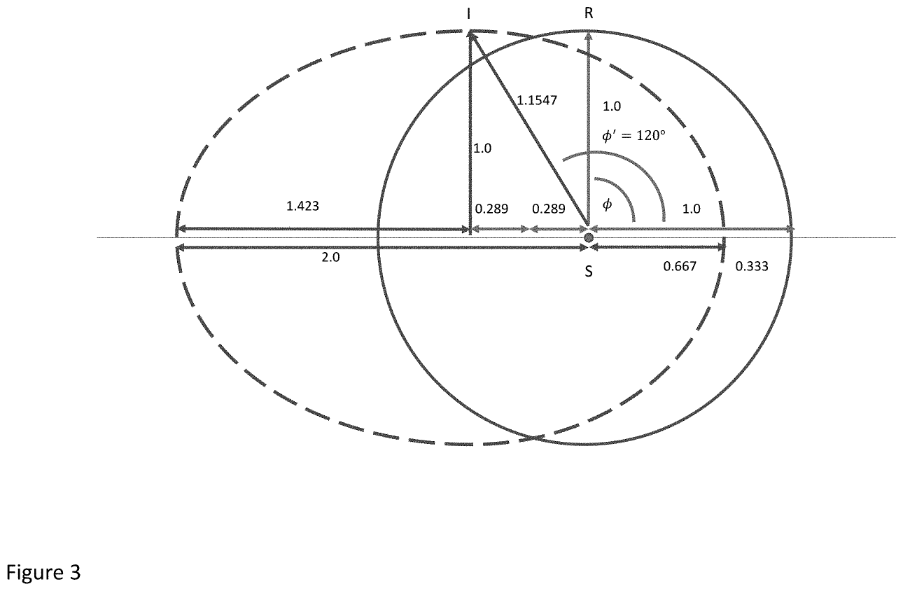

A graphical derivation of the equation for the frequency observed by a moving receiver is shown in FIG. 3), where intervals have been assigned numerical values for purposes of illustration. It is assumed that a stationary source, S, emits light in a circular pattern, where after a period T₀=1/f₀, a single wave-front is represented by a blue circle. For simplicity, it is assumed that T₀=1 second and c=1 times the distance that light travels in one second, in which case the blue circle has a radius of one light-second.

To compute the wavelengths observed by receivers moving parallel to the horizontal axis at speed v/c=0.5 (leftward), assume that an array of receivers lie on the blue circle at the end of a period. The wavelength that a given receiver experiences will be determined by a combination of the speed at which the receiver travels and the speed and direction of the next wavefront. For example, if a receiver lies on the horizontal axis at position (1,0) relative to the source, it will travel leftward at speed v while the next wavefront travels from the source toward it at speed c. This receiver will encounter the wavefront after time t governed by the relation,

v_{y}t+ct=cT₀+λ₀

In this example, t=⅔ seconds in the frame of the source. The receiver will move ⅓ light-seconds leftward while the wavefront meets it after traveling ⅔ light-seconds rightward. The wavelength experienced by this receiver will be λᵣ′=ct=⅔ light-seconds. The frequency as measured by the receiver's time-dilated clock will be,

$${f}_{r}^{′} = \frac{{γ}_{s}}{t} = \frac{3}{2} {γ}_{s} ,$$

waves per time-dilated second′. The moving receiver will measure light speed to be λᵣ′fᵣ′=γₛc meters per second′.

Similarly, a receiver positioned on the blue circle at an angle φ with respect to the source will travel leftward from point R to point I at speed vᵣ while the wavefront will travel radially at speed c from point S to point R and also from point S to point I. Note that the wavefront will reach point R before it reaches point I.

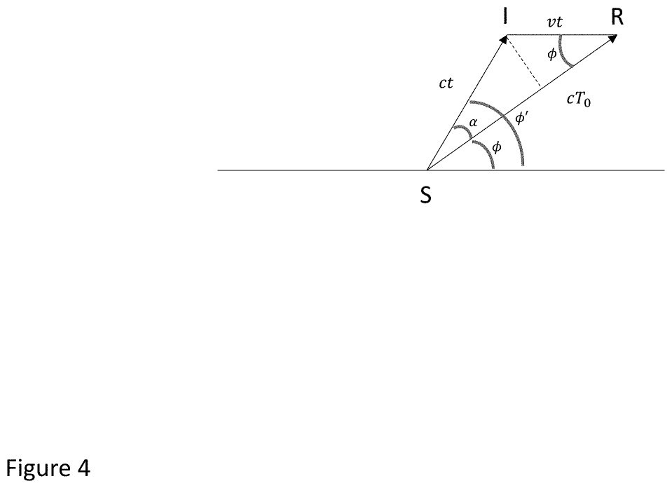

FIG. 4) illustrates an example where line SI forms an angle φ′=φ+α with the horizontal axis. The time t can be derived using,

ct cos α+vᵣt cos φ=cT₀,

where the angle α can be derived using the law of sines,

$$α = arcsin ( \frac{{v}_{r}}{c} sin ϕ )$$

Therefore,

$$t = \frac{{cT}_{0}}{{v}_{r} cos ϕ + c cos ( arcsin ( \frac{v}{c} sin ϕ ) )} = \frac{1}{{f}_{o} ( \frac{{v}_{r}}{c} cos ϕ + \sqrt{1 - {( \frac{{v}_{r}}{c} sin ϕ )}^{2}} )} .$$

A given receiver will observe wavelength to be ct meters and frequency to be,

$${f}_{r}^{′} ( alternative model ) = {γ}_{s , r} {f}_{0} ( \frac{{v}_{r}}{c} cos ϕ + \sqrt{1 - {( \frac{{v}_{r}}{c} sin ϕ )}^{2}} ) ,$$

waves per second′, where γ_{s,r}=\sqrt{1+vᵣ²/c²}.

Note that the angle φ′ in FIG. 4) is the classical aberration angle, which can also be derived by,

φ′=arctan(sin φ/(cos φ−vt)

For a receiver that is very far from the source, the angle α approaches zero, in which case the equation for the frequency observed by a moving receiver reduces to,

$${f}_{r}^{′} ( alternative model ) = {γ}_{s , r} {f}_{0} ( 1 + \frac{{v}_{r}}{c} cos ϕ ) \qquad ( 13 )$$

In the alternative model, under conditions where the source is stationary and the receiver moves longitudinally toward the source, (where vₛ=0, cos φ=1, and fₛ′=f₀; Equation (13) reduces to,

$${f}_{r}^{′} = {f}_{0} {γ}_{s , r} ( 1 + \frac{{v}_{r}}{c} )$$

The Doppler-shifted frequency at the receiver, measured in the stationary frame in waves per second, will be

$${f}_{r , z}^{′} = \frac{f \text{?}}{γ \text{?}} = {f}_{0} ( 1 + \frac{{v}_{r}}{c} ) \\ \text{?} \text{indicates text missing or illegible when filed} \qquad ( 14 )$$

In the alternative model, when the source is stationary a receiver moving longitudinally will measure light traveling at γ_{s,r}c meters per second′, and the wavelength measured by the moving receiver in meters per wave is,

$${λ}_{r , Longitudinal}^{′} = \frac{{λ}_{0}}{1 + \frac{{v}_{r}}{c}} \qquad ( 15 )$$

Neither time dilation nor length contraction (if it exists) affects the wavelength observed by a longitudinally moving receiver in vacuum. The wavelength is modulated only by the primary Doppler effect. Equation (15) could form the basis for experimental differentiation between special relativity and the alternative model, provided measurements are made in a pure vacuum without refractive media (see Impact of Refractive Media on Doppler Effect section). Unfortunately, it is difficult to measure wavelengths in a vacuum using a receiver moving extremely rapidly. Champeney et al (21) measured frequency of a rotating receiver, not wavelength.

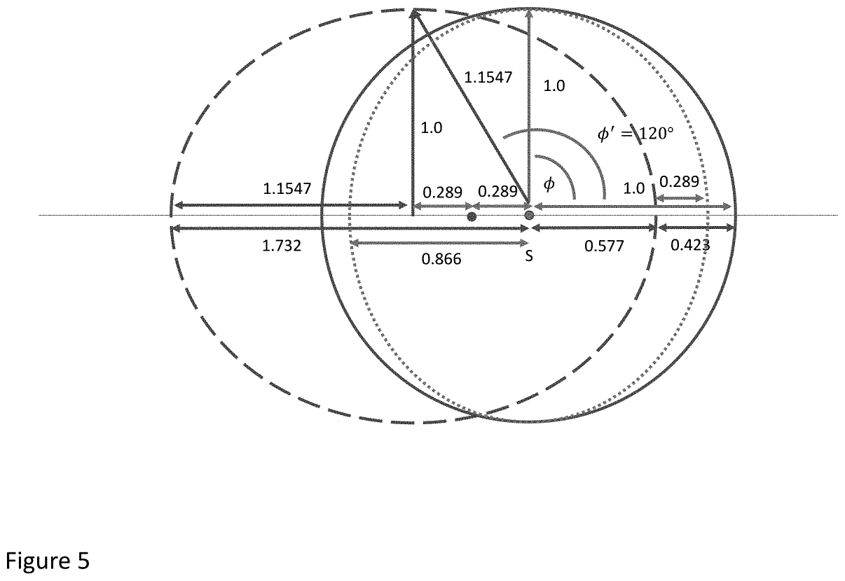

The wavelengths, frequencies, and aberration angles derived thus will differ from those derived using special relativity. However, the values obtained using the relativistic Doppler equations can be derived similarly by adjusting the initial wavefront to a length-contracted ellipse as shown in FIG. 5. Instead of the initial blue circle shown in FIG. 4 the special relativity wavefront is represented as an ellipse (green) with horizontal axis contracted by a factor of γ_{L}. The radius of this ellipse is determined by the equation,

$$r ( SR contracted ellipse ) = \frac{{c}^{2} {T}_{0}^{2}}{{γ}_{L} \sqrt{( \frac{{c}^{2} {T}_{0}^{2}}{{γ}_{L}^{2}} {sin}^{2} ϕ + {c}^{2} {T}_{0}^{2} {cos}^{2} ϕ )}}$$

Frequency for special relativity is then computed as,

$${f}_{r}^{′} ( special relativity ) = \frac{{f}_{0}}{r} ( \frac{{v}_{r}}{c} cos ϕ + \sqrt{1 - {( \frac{{v}_{r}}{c} sin ϕ )}^{2}} )$$

This frequency exactly matches that predicted by the relativistic Doppler equation for a moving receiver using relativistic aberration angles. Note that f₀ need not be multiplied by γ_{L} to adjust for time-dilation since length-contraction of the radius accomplishes this.

This reveals that the relativistic Doppler equation for a moving receiver assumes that light is emitted by a stationary source in an elliptical pattern. This elliptical pattern is not merely an illusion as perceived by the moving receiver; but according to the Lorentz transformations (as shown above) special relativity requires lengths (and wavelengths) to be contracted in the frame of the source. Once again, the outcome of the Michelson Morley experiment can only be explained by the special theory of relativity if lengths in the longitudinal dimension are contracted in the frame of the source. And therefore the eccentricity of the contracted ellipse of light must be determined by the speed of the receiver observing the light emitted by the source. Different receivers traveling at different speeds would cause the same stationary source to emit light in different elliptical patterns, again revealing a fatal conflict in the theory. Not only must the stationary frame frequency of light emitted by the source be a function of the emission angle, but the requirement that light speed emitted by the source remain constant will require the wavefronts to be emitted by the source first in the transverse directions (with respect to the movement of the receiver) followed by emission more towards the longitudinal directions. In other words, light must first “emerge” from the stationary source orthogonal to the longitudinal dimension and the spread toward the longitudinal poles, as governed by the speed of a source that might lie light years from the source. These constraints are unrealistic in the extreme.

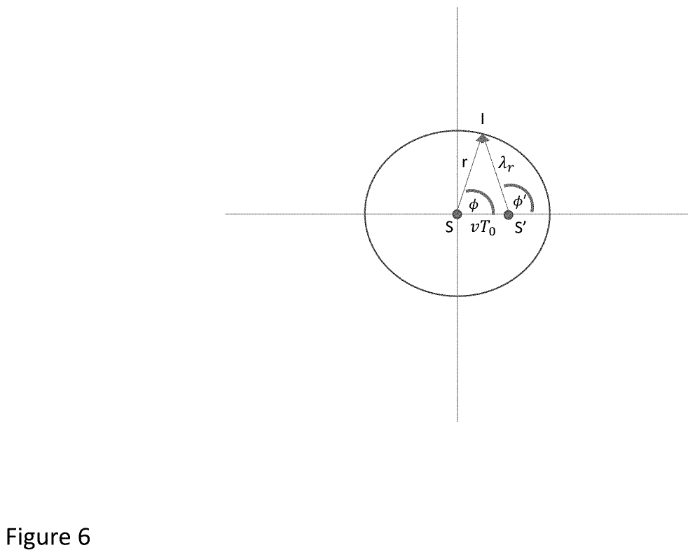

For the alternative model, the frequency and wavelength of light emitted in a vacuum by a moving source and detected by a stationary receiver can be derived using the law of cosines. FIG. 6) illustrates the emission of light from a moving source S that travels a distance vT₀ to position S′ in one period. In the alternative model, light emitted at point S travels at speed γ_{φ}c, tracing a radius of length r=γ_{φ}cT₀. The distance between S′ and the wavefront at the end of a period is the wavelength, λᵣ, between the initial wavefront emitted at point S and the subsequent wavefront emitted at point S′. For receivers that are far from the source (many wavelengths), the vT₀ distance becomes small as compared to the r distance as φ approaches π/2. For the setup in FIG. 6 where the receiver is only one wavelength from the source, this is not a concern. But as the distance between source and receiver increases, the angle opposite the vT₀ distance approaches zero and vT₀ is scaled as vT₀ cos φ. The wavelength detected by a stationary receiver far from the source is thus,

$${λ}_{r} ( alternative ) = {λ}_{O} γ \text{?} \sqrt{\frac{{v}_{s}^{2}}{{c}^{2}} {cos}^{2} ϕ + {γ}_{ϕ}^{2} - 2 {γ}_{ϕ} \frac{{v}_{s}}{c} cos ϕ} , \\ \text{?} \text{indicates text missing or illegible when filed}$$

which simplifies to,

$${λ}_{r} ( alternative ) = {λ}_{O} {γ}_{s} ( {γ}_{ϕ} - \frac{{v}_{s}}{c} cos ϕ ) . \qquad ( 16 )$$

where λ₀ is the wavelength emitted by the source when stationary. The term λ₀γₛ reflects the slowing of emission frequency by the source's time-dilated clock, which extends the period between wavefronts.

If the source emits light in a vacuum, longitudinally with respect to its velocity, Equation (16) becomes,

$${λ}_{r , vacuum} = {γ}_{s}^{2} {λ}_{0} ( 1 - \frac{{v}_{s}}{{γ}_{s} c} )$$

For purely longitudinal motion, this equation can be manipulated algebraically to yield,

$${λ}_{r , longitudinal , vacuum} = \frac{{λ}_{0}}{( 1 + \frac{{v}_{s}}{γ \text{?} c} )} \\ \text{?} \text{indicates text missing or illegible when filed} \qquad ( 17 )$$

The frequency emitted by a moving source at point S′ and detected by a stationary receiver at point I can be computed using,

$${f}_{r} ( alternative ) = \frac{{γ}_{ϕ} , c}{{λ}_{s}^{′}} = \frac{{γ}_{ϕ} , {f}_{s}^{′}}{γ \text{?} \sqrt{\frac{{v}_{s}^{2}}{{c}^{2}} {cos}^{2} ϕ + {γ}_{ϕ}^{2} - 2 {γ}_{ϕ} \frac{{v}_{s}}{c} cos ϕ}} \\ where , \\ {ϕ}^{′} = asin ( \frac{{γ}_{ϕ} {γ}_{s} sin ϕ}{\sqrt{\frac{{γ}_{s}^{2} {v}^{2}}{{c}^{2}} + {γ}_{ϕ}^{2} {γ}_{s}^{2} - \frac{2 {γ}_{ϕ} {γ}_{s}^{2} v}{c} cos ϕ}} ) , and \\ {γ}_{ϕ}^{′} = \sqrt{\frac{1 + \frac{{v}^{2}}{{c}^{2}}}{1 + \frac{{v}^{2}}{{c}^{2}} {sin}^{2} {ϕ}^{′}}} . \\ \text{?} \text{indicates text missing or illegible when filed} \qquad ( 18 )$$

A speed of γ_{φ′}c is used to compute fᵣ since the second wavefront originates at point S′ and proceeds to point I at angle φ′ and speed γ_{φ′}c. However, when the receiver is very far from the source, γ_{φ′}≈γ_{φ}, and the equation for fᵣ becomes,

$${f}_{r} ( alternative ) = \frac{{f}_{s}^{′}}{{γ}_{s} ( 1 - \frac{{v}_{s}}{{γ}_{ϕ} c} cos ϕ )} . \qquad ( 19 )$$

When the wavelength of a moving source is computed using the relativistic Doppler formula for special relativity,

$${λ}_{r} ( special relativity ) = {λ}_{0} {γ}_{L} ( 1 - \frac{{v}_{s}}{c} cos ϕ )$$

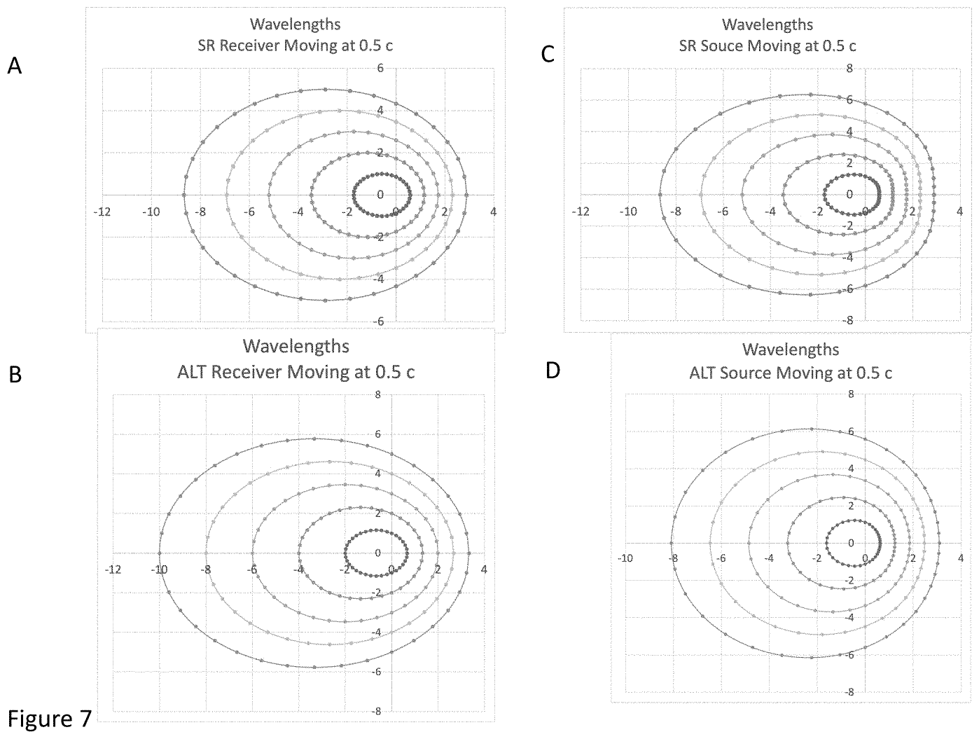

This equation produces a distorted wavefront, especially as v approaches c. And the distribution is different than the distribution of wavelengths generated by the relativistic Doppler formula for a moving receiver when using either aberration angles or normal angles (FIG. 7). This challenges the validity of the principle of relativity as incorporated into the special theory of relativity.

Under conditions where a source is moving longitudinally and a receiver is stationary, Equation (18) resolves to,

$${f}_{r} = \frac{{f}_{s}^{′}}{{γ}_{s , s} ( 1 - \frac{{v}_{s}}{{γ}_{s} c} )}$$

This formula differs from the analogous formula of special relativity, in that the gamma factor is different and light speed is γₛc instead of c. These differences could provide a basis for experimental differentiation of the alternative model from special relativity (see below).

If φ=90′, Equation (18) produces the transverse Doppler effect observed by a stationary receiver when a moving source emits light at their geometric point of closest approach. At this angle, wavelength is red-shifted to

$${γ}_{r , transverse} = \frac{c}{{f}_{r}} = {γ}_{s} {λ}_{0}$$

When a source moves at vₛ=γ_{s,s}v when vᵣ=0, the wavelength will be the same as when vᵣ=v and vₛ=0. Under these conditions, Equation (Error! Reference source not found.) becomes,

$${λ}_{r , longitudinal} = \frac{{γ}_{s} c}{{f}_{r}} = \frac{{λ}_{0}}{( 1 + \frac{{γ}_{s , s} v}{{γ}_{s , s} c} )} = \frac{{λ}_{0}}{( 1 + \frac{v}{c} )} \qquad ( 20 )$$

When both source and receiver move longitudinally with respect to a stationary observer, frequency is determined by Equation (12), and wavelength is computed by considering relative light speed.

$$relative light speed at moving receiver = c \sqrt{1 + \frac{{( {v}_{s} + {v}_{r} )}^{2}}{{c}^{2}}}$$

Wavelength perceived by the moving receiver will be relative light speed divided by frequency,

$${λ}_{r}^{′} = \frac{c \sqrt{1 + \frac{{( {v}_{s} + {v}_{r} )}^{2}}{{c}^{2}}}}{{f}_{r}^{′}}$$

If vₛ=−vᵣ, then fᵣ′=f₀ and λᵣ′=λ₀. Which means that a receiver traveling at the same speed and direction as a source in an IRF will perceive source frequency to be f₀ waves per second′, wavelength to be λ₀ meters per wave, and light speed to be c meters per second′.

If velocities are equal (vᵣ=vₛ=v), the relationship between source and receiver frequencies for the alternative model, is,

$${f}_{r}^{′} = {f}_{s}^{′} \frac{1 + \frac{v}{{γ}_{s , s} c}}{1 - \frac{v}{{γ}_{s , s} c}}$$

Therefore, when a receiver and a source move toward each other at the same speed relative to a stationary medium (positive v means they are moving toward each other), both movements contribute to an increase in frequency at the receiver. This result is similar to the one produced by Equation (11), except light speed with respect to the stationary frame is γ_{s,s}c instead of c, which affects the final frequency. Equation (11) approaches infinity as v approaches c, and zero when v approaches −c; the alternative version does not. In the alternative model, longitudinal light coming from a moving source travels faster than the source, and so light from the source will reach the receiver before the source reaches the receiver. Longitudinal light coming from a stationary source travels at c, and so the frequency observed by a receiver moving away from a stationary source at speed c will be zero (the light never reaches the receiver and the receiver sees no waves). The frequency observed by a receiver moving at c towards a stationary source will be 2\sqrt{2}f₀ waves per second′, and wavelength will be λ₀/2 meters. This difference might potentially provide a means for differentiating the alternative model from special relativity.

Doppler Transformations

(Note the symbols Δ and d are used interchangeably in this specification to represent small changes.) When the longitudinal Doppler equations are expressed in reference frame transformation format, the “proper period” can be considered to be,

$${dt}^{′} = \frac{1}{{f}_{s}} = \frac{1}{{f}_{0}}$$

When the source is stationary, fₛ is denominated in waves per second, and dt′ is denominated in seconds per wave. When the source moves, source frequency fₛ′ and proper period dt′ maintain their numerical values when measured in source-frame waves per seconds′ and seconds′ per wave respectively. These seconds′ can be converted to stationary-frame seconds per wave by multiplying dt′ by γ_{s,s} seconds per second′, but the computation of dt requires further manipulation (see below). If the source remains stationary and the receiver moves, the source emission frequency remains f₀ waves per second, but the moving receiver perceives these as γ_{s,r}f₀ waves per receiver seconds′ (The magnitude of seconds per second′ is determined by the velocity of the observer determining time. If the source and receiver are both moving, each will measure time based on their respective velocities. A second can only be universal if there is a preferred frame of reference by which to define a second.). Special relativity and the alternative model agree on these principles, but differ with respect to the formulas for gamma.

The proper length in meters is,

dx′=λ₀

If the source moves, it's emission wavelength increases by a factor of γ_{s,s} or γ_{L,s} depending on the model (transverse Doppler red shift). In the alternative model, if the receiver moves transversely, the source and receiver continue to observe a wavelength of λ_{Q}, but the receiver will measure a frequency of γ_{s,r}f₀ waves per second′ and a speed of light equal to γ_{s,r}c meters per second′ when the receiver is geometrically at right angles to the approaching light. In special relativity theory, if the receiver moves transversely, holding light speed to c meters per second′ would require the source and receiver to observe a contracted wavelength of λ₀/γ_{L,s} meters, the receiver to measures a frequency of γ_{L,r}f₀ waves per second′, and a speed of light equal to c meters per second′.

For both special relativity theory and the alternative model, if a receiver is stationary, light speed emitted transversely by either a stationary or moving source, measured in meters per second by the stationary receiver (convert meters per second′ to meters per second by dividing by γₛ), will be,

$$\frac{{dx}^{′}}{{dt}^{′}} transverse , stationary receiver = {γ}_{s} {λ}_{0} ( \frac{{f}_{0}}{{γ}_{s}} ) = c$$

However, for the alternative model, a receiver moving transversely will measure light to be moving at γ_{s,r}c meters per second′ when at the point of closest approach to the source,

$$\frac{{dx}^{′}}{{dt}^{′}} transverse , moving receiver , alt = {λ}_{0} \cdot {γ}_{s , r} {f}_{0} = {γ}_{s , r} c$$

whereas special relativity theory contemplates the moving receiver to measure light speed at c contracted meters per second′,

$$\frac{{dx}^{′}}{{dt}^{′}} transverse , moving receiver , SR = \frac{{γ}_{L , r} {λ}_{0} {f}_{0}}{{γ}_{L , r}} = c \qquad$$

Longitudinal light follows similar reference frame transformation principles. For the alternative model, stationary receiver wavelength is light speed multiplied by dt seconds (A minus sign is used to conform with the convention of assigning a positive value to velocities that are directed toward the other object (source or receiver). Positive source and/or receiver velocities will shorten wavelength.),

$$dx alt = {λ}_{r} = lightspeed \times dt = {γ}_{s , s} c {γ}_{s , s} {dt}^{′} - \frac{{γ}_{s , s} {cv}_{s} {dx}^{′}}{{c}^{2}} = {γ}_{s , s}^{2} {λ}_{0} - {γ}_{s , s} {v}_{s} {λ}_{0} / c$$

The time period as observed by a stationary receiver in waves per second, is

$$dt = \frac{1}{{f}_{r}} = {γ}_{s , s} {dt}^{′} - \frac{{v}_{s} {dx}^{′}}{{c}^{2}} = \frac{{γ}_{s , s} {λ}_{0}}{c} - \frac{{v}_{s} {λ}_{0}}{{c}^{2}}$$

And longitudinal light speed as detected by a stationary receiver is,

$$\frac{dx}{dt} = {γ}_{s , s} c$$

Energy

In 1901, Max Planck proposed that energy could be quantized in proportion to frequency [²⁴],

E=hf

which Einstein referenced to explain the photoelectric effect [²⁵]. Multiplying both sides of Equation (11) by Planck's constant yields what would be predicted for photon energy as observed by a moving receiver according to special relativity (as measured in joule·second/second′, a unit that is smaller than a joule by a factor of γ_{L}),

$${E}_{r}^{′} = {hf}_{s}^{′} \frac{{γ}_{L , r} ( 1 + \frac{{v}_{r} cos {ϕ}_{r}}{c} )}{{γ}_{L , s} ( 1 - \frac{{v}_{s} cos {ϕ}_{s}}{c} )}$$

If this equation is divided by γ_{L,r} the units are converted to stationary frame joules (This equation represents energies as measured in the stationary frame. The frequencies have been divided by their respective time-dilation factors to provide meaningful comparisons in the same (stationary) frame. Multiplying both sides of the equation by the same numerical value for Planck's constant yields energy in stationary frame joules on both sides of the equation. It is conceivable that if Planck were to have derived his constant in a different inertial reference frame having a different clock rate, yielding dimensional units of joule′−seconds′, a different numerical value for the constant would have been derived. If such dimensional units were used for a moving frame h′, it could be converted to a stationary frame h by dividing it by γ_{s,r} in the same manner that fᵣ′ is converted to stationary frame However, since Equation (11) transforms both source and receiver frames to a single, stationary frame, it is equally valid to use the stationary frame value of Planck's constant on both sides of the equation to yield dimensional units of stationary frame joules.).

$${E}_{r , z}^{′} = {hf}_{s}^{′} \frac{( 1 + \frac{{v}_{r} cos {ϕ}_{r}}{c} )}{{γ}_{L , s} ( 1 - \frac{{v}_{s} cos {ϕ}_{s}}{c} )} \qquad ( 21 )$$

When the source is stationary and the receiver is in motion, the photon energy detected by the moving receiver, as expressed in stationary frame joules is (One can think of this equation in terms the receiver encountering particles, each having energy hf₀, at a rate proportional to 1+v_{r,l}/c. For example a machine gun might fire bullets having a mass of m, traveling at speed c, at a rate of f₀ bullets per second, where each bullet has energy hf₀. If a target moves directly toward or away from the machine gun, the target will encounter more or fewer bullets per second depending on the ratio of the speed of the target divided by the speed of the bullets. The movement of the target does not increase the mass, stationary frame speed, or energy of each bullet, merely the rate at which the target encounters the bullets.),

$${E}_{r , z}^{′} = {hf}_{0} ( 1 + \frac{{v}_{r} cos {ϕ}_{r}}{c} )$$

When receiver and source velocities are zero, the equation further simplifies to,

E_{r,s}′=hf₀

which is the Planck-Einstein relation for light coming from a stationary source as detected by a stationary receiver.

According to Einstein [20] and to Equation (11), when a receiver is stationary and a source is moving, the energy of a photon coming longitudinally from the moving source is (in joules),

$${E}_{r} = {hf}_{r} \frac{{hf}_{s}^{′}}{{γ}_{L , s} ( 1 - \frac{{v}_{s} cos {ϕ}_{s}}{c} )}$$

And when source motion is strictly transverse, photon energy at the point of closest approach as seen in the stationary frame is,

$${hf}_{r} = \frac{{hf}_{s}^{′}}{{γ}_{L , z}} = \frac{{hf}_{0}}{{γ}_{L , s}}$$

This is consistent with a moving source emitting lower-frequency photons transversely than a stationary source.

If the stationary frame energies for light transmitted and received longitudinally are equated for a moving source/stationary receiver and a stationary source/moving receiver, where f_{z}′ is shown as its numerical equivalent f₀,

$$\frac{{hf}_{0}}{{γ}_{L , s} ( 1 - \frac{{v}_{s}}{c} )} = {hf}_{0} ( 1 + \frac{{v}_{r}}{c} )$$

one can solve for the speed at which a moving receiver experiences a photon coming longitudinally from a stationary source to have energy (expressed in stationary frame joules) equal to the energy that a stationary receiver experiences when colliding with a photon coming from a moving source. Solving for vᵣ,

$${v}_{r} = \frac{c}{{γ}_{L , s} ( 1 - \frac{{v}_{s}}{c} )} - c$$

which can be rearranged using a conversion valid for longitudinal light,

$$\frac{c}{{γ}_{L , s} ( 1 - \frac{{v}_{s}}{c} )} \times \frac{{γ}_{L , s} ( 1 + \frac{{v}_{s}}{c} )}{{γ}_{L , s} ( 1 + \frac{{v}_{s}}{c} )} = {γ}_{L , s} ( c + {v}_{s} )$$

to yield,

vᵣ=(γ_{L,s}−1)c+γ_{L,s}vₛ (22)

Equation (22) has significant implications. It shows that a moving receiver must move toward a stationary source faster than a moving source must move toward a stationary receiver in order for the moving receiver to encounter photons having stationary frame energy equal to that of photons coming from the moving source. A receiver must travel not only γ_{L,s} times faster than a moving source (in special relativity but not in the alternative model—see below), but must also travel (γ_{L,s}−1)c faster yet. This latter term is intriguing. It represents the difference between speeds γ_{L,s}c and c; that is, an amount by which some speed exceeds speed c. In other words, part of the energy difference can be replicated by a receiver traveling faster than a source by an amount equal to the amount by which speed γ_{L,z}c exceeds speed c. It should be emphasized that this finding is true for special relativity and the alternative model; but nothing from the alternative model has been invoked to reach this conclusion for special relativity.

The (γ_{L}−1)c term reveals that a moving receiver will have to travel in the direction of the source by an additional amount of speed equal to the difference between a speed faster than light speed, γ_{L}c and speed c. And the receiver must attain this differential speed in the direction of the source regardless of whether the source has moved toward or away from the stationary receiver when the source emitted a photon (since γ_{L}≥1 regardless of the direction of source motion). This phenomenon cannot be caused or modulated by the action of a primary Doppler effect (“PDE”), since a PDE cannot result in an increase of frequency and energy in both directions. This finding is consistent with a moving source emitting parallel and antiparallel photons possessing greater combined energy than photons emitted by a stationary source (and thus losing more energy than a stationary source), where such greater energy is related in some way to a speed that exceeds light speed c.

If photons behaved like massive objects, this energy difference could be represented as photons traveling at speed γ_{L,s}c when emitted longitudinally by a moving source versus speed c when emitted by a stationary source. Particles/wave-fronts do not take on a higher frequency simply because transmission speed is increased. Absent the primary Doppler effect, particle/wave-front frequency is determined by the core emission frequency at the source, not particle/wave-front speed. Thus, if the wave-nature and particle-nature of light were to both travel at γ_{L,s}c, the higher speed would not in itself affect wave frequency, but (in contrast to the teachings of the Plank-Einstein relation) it would affect particle energy.

These findings can be explained by postulating that the speed of photons emitted by a moving source depends on the angle of emission,

vₚ=c\sqrt{(c²+vₛ²)/(c²+vₛ² sin² φ)}=cγ_{φ}

That is, photons (and light waves) emitted in the longitudinal direction (φ=0 or π) travel \sqrt{1+vₛ²/c²} faster than photons emitted transversely (which are emitted at speed c when cos φ=0); and travel faster than photons emitted in any direction by a stationary source (which are emitted at speed c when vₛ=0).

If a photon were to be modeled as a Newtonian particle, its kinetic energy would be,

KE_{Newton}=½m_{N}vₚ²

To be consistent with the Planck-Einstein convention, the “mass-energy” of a photon emitted by a stationary source will be defined as

$${m}_{0} = \frac{{m}_{N}}{2} = \frac{{E}_{o}}{{c}^{2}} = \frac{{hf}_{0}}{{c}^{2}}$$

Therefore, the emission energy of a photon coming from a moving source subject to transverse Doppler effect (“TDE”) time dilation (momentarily ignoring the PDE) would be approximated by,

$${E}_{photon} = \frac{{m}_{0}}{{γ}_{z , s}} {( c {γ}_{ϕ} )}^{2} = \frac{{m}_{0} {c}^{2}}{{γ}_{z , s}} ( {c}^{2} + {v}_{s}^{2} ) / ( {c}^{2} + {v}_{s}^{2} {sin}^{2} ϕ )$$

where γ_{s,s} is an angle-independent time dilation (TDE) factor, γ_{s,s}=\sqrt{1+vₛ²/c²}. That is, when φ=±π/2, photons traveling at speed γ_{φ}c possess greater energy than photons traveling at speed c. The additional speed accounts for a γ_{φ}² fold increase in the energy of photons emitted in opposite directions longitudinally versus transversely.

When two photons are emitted in opposite directions by a moving source, the PDE-modulated, average emission energy is,

$${E}_{2 photons} = \frac{{m}_{0} {c}^{2}}{{γ}_{s , s}} ( \frac{0.5}{1 - \frac{{v}_{s} cos ϕ}{{γ}_{ϕ} c}} + \frac{0.5}{1 + \frac{{v}_{s} cos ϕ}{{γ}_{ϕ} c}} ) = \frac{{m}_{0} {c}^{2}}{{γ}_{s , s} ( 1 - \frac{{v}_{s}^{2} {cos}^{2} ϕ}{{γ}_{ϕ}^{2} {c}^{2}} )}$$

Summing the equation on the right over 360′ and averaging yields an amount of energy that is greater than that of the hf₀. That is, a moving source emits photons of higher energy when averaged in all directions as compared to the energy from a stationary source. Special relativity fails to account for this required incremental energy (and lower entropy).

The symbol Σₚ will be defined as,

$${\sum }_{p} = \frac{1}{( 1 - \frac{{v}_{s}^{2} {cos}^{2} ϕ}{{γ}_{ϕ}^{2} {c}^{2}} )}$$

The asymmetric distribution of energy associated with (not caused by) the PDE can be computed by subtracting average photon energy from the energy of a single photon emitted at the same angle as one of the two photons,

$$Δ {E}_{PDE} ( ϕ ) = \frac{{m}_{0} {c}^{2}}{{γ}_{s , s}} ( \frac{1}{( 1 - \frac{{v}_{s} cos ϕ}{{γ}_{ϕ} c} )} - {\sum }_{p} )$$

Eq. (19) can be conformed according to the postulate of the present paper and multiplied by Planck's constant to yield,

$${E}_{p} = \frac{{hf}_{0}}{{γ}_{s , s}} \frac{1}{1 - \frac{{v}_{s} cos ϕ}{{γ}_{ϕ} c}} = \frac{{\sum }_{p}}{{γ}_{s , s}} {m}_{0} {c}^{2} ( 1 + \frac{{v}_{s} cos ϕ}{{γ}_{ϕ} c} ) \qquad ( 24 )$$

The m₀c²Σₚ/γ_{s,s} term represents the bi-directional average photon energy for a given angle φ. The velocity term represents the PDE modulation of that energy. Integration of this PDE-term over 360′ yields zero, reflecting its passive nature. Note that when transmission is longitudinal (i.e. cos φ=1) then Σₚ=γ_{φ}², in which case

Eₚ=γₛm₀c²

In other words, photons obey the mass-energy relation when viewed longitudinally, provided the appropriate gamma factor is used.

When the source is stationary, this reduces to the mass-energy relation,

Eₚ=m₀c²

When cos φ=0, γ_{φ}=1 and the energy of a transverse photon from a moving source is,

$${E}_{P} = \frac{1}{{γ}_{s , s}} {m}_{0} {c}^{2} = \frac{{hf}_{0}}{{γ}_{s , s}}$$

Reassuringly, Eq. (24) exactly equals Planck's constant times Eq. (19) for all angles of φ, where Eq. (19) has been conformed to a photon speed of γ_{φ}c. Eq. (24) reveals that the core emission energy from a moving source is a function of emission angle and source speed, as then further modulated by PDE changes in the aggregate photon density leading and lagging the moving source.

For strictly longitudinal motion in the alternative model (cos φ=1), if the stationary frame energies are equated for a moving source/stationary receiver and a stationary source/moving receiver, where fₛ′ is shown as its numerical equivalent f₀,

$$\frac{{hf}_{0}}{{γ}_{s , s} ( 1 - \frac{{v}_{s}}{{γ}_{s , s} c} )} = {hf}_{0} ( 1 + \frac{{v}_{r}}{c} )$$

one can solve for the speed at which a moving receiver experiences a photon coming longitudinally from a stationary source possessing energy (in joules) equal to the energy that a stationary receiver experiences when colliding with a photon coming from a moving source. Solving for vᵣ,

$${v}_{r} = \frac{c}{{γ}_{s , s} ( 1 - \frac{{v}_{s}}{{γ}_{s , s} c} )} - c$$

which can be rearranged to separate out a vₛ term using a conversion valid for longitudinal light,

$$\frac{c}{{γ}_{s , s} ( 1 - \frac{{v}_{s}}{{γ}_{s , s} c} )} x \frac{{γ}_{s , s} ( 1 + \frac{{v}_{s}}{{γ}_{s , s} c} )}{{γ}_{s , s} ( 1 + \frac{{v}_{s}}{{γ}_{s , s} c} )} = {γ}_{s , s} ( c + {v}_{s} / {γ}_{s , s} )$$

to yield,

vᵣ=(γ_{s,s}−1)c+vₛ (25)

This equation is very similar to Equation (22) of special relativity except that there is no gamma factor modifying the vₛ term, and γ_{s,s} uses the alternative model formula rather than the Lorentz formula. This means that the speed that a receiver must travel longitudinally to encounter photons with energy equal to the energy of photons coming longitudinally from a moving source is simply (γ_{s,s}−1)c faster than vₛ. This is consistent with the alternative model, where photons emitted longitudinally by a moving source travel at γₛc. These relationships, and Equation (25) imply that light emitted longitudinally from a moving source travels at speed γₛc, and that this fact is buried deep within the relativistic energy and Doppler equations.

If the value of vᵣ from Equation (25) is used in the energy equation for a moving receiver in the stationary frame (Equation 14),

$${E}_{r , s}^{′} = {hf}_{0} + {hf}_{0} \frac{( {γ}_{s , s} - 1 ) c + {v}_{s}}{c} = {hf}_{0} ( {γ}_{s , s} + \frac{{v}_{s}}{c} ) = {E}_{r}$$

confirming that moving versus stationary receiver energies are equal when receiver velocity equals (γ_{s,s}−1)c+vₛ.

A receiver receding from a stationary source will need to travel away c(γ_{s,s}−1) less rapidly than a receding source relative to a stationary receiver in order to encounter the same energy as that encountered by the stationary receiver. By receding less rapidly, the receiver increases the relative speed of the photon emitted by the stationary source, and the factor of c(γ_{s,s}−1) compensates for the difference in speed between a photon emitted at γ_{s,s}c from the receding source versus a photon emitted at c from a stationary source.

Analogous to Einstein's derivation of the mass-energy relation for moving receivers [²⁶], Equation (23) shows that when two photons are emitted in opposite directions from a moving source, the average energy is,

$$Δ {E}_{moving source average}^{′} = \frac{{m}_{0}}{{γ}_{s , s}} {( {γ}_{ϕ} c )}^{2}$$

If ΔE_{source} is the average change in energy of a stationary source (γ_{s,s}=γ_{φ}=1) after emitting a single photon,

$$Δ {E}_{source}^{′} - Δ {E}_{source} = \frac{{m}_{0}}{{γ}_{s , s}} {( {γ}_{ϕ} c )}^{2} - {m}_{0} {c}^{2} = ( \frac{{γ}_{ϕ}^{2}}{{γ}_{s , s}} - 1 ) {m}_{0} {c}^{2}$$

When emission is longitudinal γ_{φ}=γ_{s,s}, and therefore,

ΔE_{source}′−Δ_{source}=γ_{s,s}m₀c²−m₀c²=(γ_{s,s}−1)m₀c²

This equals Einstein's formula for the change in kinetic energy of a moving source versus a stationary source after emitting a photon (using the more general γ_{s,s} factor instead of the Lorentz factor), derived directly from Newton's kinetic energy formula without the truncation of an infinite series (a criticism of Einstein's derivation for a moving receiver). However, when emission is transverse,

$$Δ {E}_{source}^{′} - Δ {E}_{source} = \frac{1}{{γ}_{s , s}} {m}_{0} {c}^{2} - {m}_{0} {c}^{2} = ( \frac{1}{{γ}_{s , s}} - 1 ) {m}_{0} {c}^{2}$$

A moving source loses less energy than a stationary source upon transverse photon emission (red shift). A stationary observer will consider such a moving source to retain more energy than a stationary source counterpart.

The Relationship Between γₛ and γ_{L}

The energy equations of the alternative model and special relativity are closely related, except that γₛ is the more general factor for kinetic energy, whereas the Lorentz factor is appropriate when the source has been accelerated with the use of a field that operates at speed c. The γₛ factor does not require the untenable concept of length contraction; and it transforms to the Lorentz factor when forces are mediated by fields at speed c.

The more general form of the mass-energy relation is then

E=γₛmc²

which implies a more general energy-momentum relation,

E=\sqrt{m²c⁴+p²c²}=\sqrt{m²c⁴+m²v²c²}=mc²\sqrt{1+v²/c²}

When is replaced with γ_{L}vₑ (where vₑ is the velocity of a particle accelerated in a field that acts at speed c), then the energy-momentum relation transforms into,

$$E = {mc}^{2} \sqrt{1 + {γ}_{L}^{2} {v}_{e}^{2} / {c}^{2}} = \frac{{mc}^{2}}{\sqrt{1 - \frac{{v}_{s}^{2}}{{c}^{2}}}} = {γ}_{L} {mc}^{2}$$

The origin of the γ_{L,s}vₛ term in Equation (22) now becomes more clear, since there is no analogous gamma factor in Equation (25). The answer is related to the peculiarities of relativistic mechanics. In special relativity, particles are accelerated by a constant field operating at speed c according to,

α=F/(γ_{L}³m₀)

As particle velocity increases, γ_{L}³ increases, causing less and less acceleration of the particle under a constant field. The velocity of such a particle is equal to its momentum divided by the Lorentz gamma factor times the particle's rest mass.

$$v = \frac{p}{{γ}_{L} {m}_{0}} = \frac{Ft}{{γ}_{L} {m}_{0}}$$

Stated differently,

$${γ}_{L} v = \frac{Ft}{{m}_{0}}$$

In Newtonian mechanics, Newtonian velocity is

$${γ}_{N} = \frac{Ft}{{m}_{0}}$$

In other words, under the laws of special relativity, particle velocity is gamma fold slower than the same particle accelerated under Newtonian mechanics,

$$v = \frac{{v}_{N}}{{γ}_{L}}$$

It is common to find particle velocity accompanied by a Lorentz gamma factor throughout special relativity, as exemplified in Equation (22) and in the formula for momentum. The alternative model does not follow the same laws of force and acceleration as does special relativity.

Interestingly, the Lorentz inverted transformation for distance also reveals the relationship between velocity in special relativity versus in the alternative model.

$${dx}^{′} = {γ}_{L} dx - {γ}_{L} vdt = {dx}^{′} ( {γ}_{L}^{2} - \frac{{γ}_{L}^{2} {v}^{2}}{{c}^{2}} )$$

$$where$$

$$dx = {γ}_{L} {dx}^{′} + {γ}_{L} {vdt}^{′} and dt = {γ}_{L} {dt}^{′} + {γ}_{L} {vdx}^{′} / {c}^{2}$$

$$Therefore , \\ {γ}_{L}^{2} - \frac{{γ}_{L}^{2} {v}^{2}}{{c}^{2}} = 1$$

$$and$$

$${γ}_{L} ( v ) = \sqrt{1 + \frac{{γ}_{L}^{2} {v}^{2}}{{c}^{2}}} = {γ}_{s} ( {γ}_{L} v ) = \frac{1}{\sqrt{1 - \frac{{v}^{2}}{{c}^{2}}}}$$

It then follows that,

$${γ}_{L} ( v / {γ}_{s} ) = \frac{1}{\sqrt{1 - \frac{{v}^{2}}{{γ}_{s}^{2} {c}^{2}}}} = \sqrt{1 + \frac{{v}^{2}}{{c}^{2}}} = {γ}_{s} ( v )$$

In other words, the inverted Lorentz transformation for distance dx′ shows that γ_{L} and γₛ are the same when v is replaced with v/γₛ in the formula for γ_{L} and when v is replaced with γ_{L}v in the formula for γₛ. Essentially γₛ is the appropriate gamma factor when forces act directly on objects (such as when ejecting fuel from the back of a rocket) rather than being acted upon by a field that operates at speed c from a distance. γ_{L} is the appropriate gamma factor when a force is transmitted by a field that acts at speed c (such as with an electromagnetic field).

To simplify the nomenclature somewhat, the following variables are now renamed: v_{e,SR}=vₑ, γ_{L,e}=γ_{L,e}. A reconciliation of Equations (22) and (25) shows that vₛ=γ_{L,e}vₑ when photon energies are equalized. Therefore, when a source travels at vₑ in the special relativity model, it emits photons having the same energy as those emitted by a source traveling at vₛ=γ_{L,e}vₑ in the alternative model. This suggests that objects traveling at vₑ in the special relativity model are either a) traveling faster than recognized, b) associated with additional energy that is not embodied solely in the longitudinal speed of the particle, or c) the light speed of the system is faster than c, and the ratio of vₑ/c is equivalent to vₛ/γₛc.

For massive objects, when vₛ=γ_{L,e}vₑ, then

γₛ=γ_{L,e}=\sqrt{1+vₛ²/c²}

and when this is multiplied by mc²,

γₛmc²=γ_{L,e}mc²=\sqrt{m²c⁴+m²vₛ²c²}=\sqrt{m²c⁴+γ_{L,e}²m²vₑ²c²}

This is Einstein's relativistic energy-momentum relation (It should be noted that velocity in these equations can be computed with the velocity addition formula if needed.),

γmc²=\sqrt{m²c⁴+γ²m²v²c²}

This further supports the notion that particles traveling at vₑ, under conditions consistent with special relativity, may be associated with additional energy (by a factor of γ_{L,s}) not embodied within the longitudinal velocity of the particle as measured in the stationary frame. This is the “relativistic” adjustment to velocity found in the relativistic energy-momentum relation.

Special relativity provides for a computation of kinetic energy by subtracting rest energy from total energy.

E_{kinetic}=Eₜₒₜₐₗ−Eᵣₑₛₜ=(γ_{L,e}−1)mc²

In the alternative model, kinetic energy can be computed similarly,

E_{kinetic}=Eₜₒₜₐₗ−Eᵣₑₛₜ=(γₛ−1)mc²

The MacLaurin series expansion of γₛ−1 is,

$${γ}_{s} - 1 \approx \frac{1}{2} {v}^{2} / {c}^{2} - \frac{3}{8} {v}^{4} / {c}^{4} + \frac{1}{16} {v}^{6} / {c}^{6} - …$$

When the first term of this expansion is multiplied by mc² the result is the familiar ½mv². As IRF velocity and/or object velocity within an IRF increases, the higher order terms become significant, and cause this series expansion to deviate from the series expansion of the Lorentz γ factor. Therefore, both models predict the same rest energy, but an object moving at speed v in the alternative model would be associated with less kinetic energy than an object moving at speed v in special relativity.

There is little numerical difference between the γₛ−1 and γ−1 terms at low velocity. However, as velocity grows large, special relativity predicts that kinetic energy tends toward infinity. This has led to the belief that it would require an infinite amount of energy to accelerate a mass to the speed of light. In the alternative model, the kinetic energy needed to accelerate a mass to the speed of light would be (\sqrt{2}−1) times mc², which would be possible if the mass is accelerated with a force that itself is not limited by transmission speed c. It is still a large amount of energy, but nowhere near the infinite amount of energy required as predicted by special relativity (Interestingly, the alternative model predicts that the energy of a particle increases in proportion to γₛ, and the harmonic frequency of a particle decreases in proportion to γₛ (higher order Doppler effect). Thus the increase in kinetic energy of the center of mass of a moving IRF is directly proportional to the decrease in kinetic energy resulting from “clock rate time-dilation”.).

Since total energy can be expressed in terms of either the Lorentz gamma factor or the alternative gamma factor,

Eₜₒₜₐₗ=γ_{L,e}mc²=γₛmc²

the values of these gamma factors can be computed by taking the ratio of total energy divided by rest energy,

Eₜₒₜₐₗ/Eᵣₑₛₜ=γ_{L,e}=γₛ

The corresponding velocities can then be obtained by rearrangement,

vₛ/c=\sqrt{(Eₜₒₜₐₗ/Eᵣₑₛₜ)²−1}

and

vₛ/c=\sqrt{1−(Eᵣₑₛₜ/Eₜₒₜₐₗ)²}

In other words, if the total energy and rest energy are known, then vₛ and vₑ can be computed. If the actual, measured velocity matches a computed velocity of vₑ/c, then the system is such that velocity has been tempered by the transmission speed of the accelerating force (for example, electromagnetic forces act at speed c, and cannot accelerate a particle beyond that speed regardless of how much energy has been applied to the particle). Whereas if the actual measured velocity matches a computed velocity of vₛ/c, then the accelerating forces are not limited by a transmission speed of c.

As with Einstein's model, the term m²c⁴ is invariant in the alternative model,

γₛ²m²c⁴−m²vₛ²c²=m²c⁴

Momentum

The energy-momentum relation can be written in terms of momentum.

Eₜₒₜₐₗ=γₑmc²=\sqrt{m²c⁴+p²c²}

Using the velocity of the alternative model, momentum is computed using the classical formula,

p=mvₛ

In contrast, relativistic momentum is defined using a gamma factor to bring velocity to the equivalent of vₛ,

p_{SR}=mγ_{L,e}vₑ

Physicists once believed that mγ_{L,s} was the “relativistic mass”, where mass increased as a particle's velocity increased. The analysis above suggests that there is something unique about particles traveling at vₑ under “relativistic conditions”; that they seem to be associated with an amount of additional momentum and energy not represented in the longitudinal velocity of the particle itself.

Photon Mass/Energy

It is generally believed that photons have no mass, essentially because Lorentz's gamma factor equals infinity when v=c, which would cause the relativistic momentum, mγv, to become infinite. The special relativity solution to this issue is to deem the mass of a photon to be zero. Hypothetically, infinity multiplied by zero could equal something that corresponds with experimental measurement, but it is an odd way to compute a finite number. Special relativity assumes that the m²c⁴ term of the energy-momentum relation is zero for a photon, and that the γ²m²v²c² term, where zero mass is squared and multiplied by infinity squared, and then multiplied by v², which is assumed to be equal to all equals photon energy squared. Which somehow leads to,

E_{photon,special relativity}=\sqrt{γ²m²c⁴}=\sqrt{∞²0²c⁴?}=hf

where h is Planck's constant. Based on that assumption, special relativity then suggests that photon momentum equals a photon's energy divided by C.

$${p}_{photon , special relativity} = \frac{{E}_{photon}}{c} = hf / c$$

The alternative model is more concrete. γₛ does not go to infinity at speed c; instead it equals \sqrt{2}.

Drawing from the alternative model equation for stationary receiver frequency, the energy of a photon emitted by a moving source toward a stationary receiver is,

$${E}_{p} = \frac{{hf}_{0}}{{γ}_{s , s}} \frac{1}{1 - \frac{{v}_{s} cos ϕ}{{γ }_{ϕ} c}} = \frac{{\sum }_{p}}{{γ}_{s , s}} {m}_{0} {c}^{2} ( 1 + \frac{{v}_{s} cos ϕ}{{γ}_{ϕ} c} )$$

It is interesting to note that photon mass-equivalent energy is not a constant. The larger the emission frequency of a given source element energy transition, fₛ′, the greater the mass-equivalent energy of the emitted photon. Note that when transmission is longitudinal (i.e. cos φ=1) them Σₚ=γ_{φ}², in which case

Eₚ=γₛm₀c²

In other words, photons obey the mass-energy relation when viewed longitudinally, provided the appropriate gamma factor is used.

Whether a photon has “true mass” or a mass-equivalent of energy is beyond the scope of this paper. However, photons are subject to gravitation, create an impact upon collision, and are part of a group of gauge bosons, the other members of which W⁺, W⁻, and Z⁰, have mass (Note that in the alternative model, the mass, momentum, and energy of a photon increase linearly with frequency, and therefore the model is consistent with the energy of a photon traveling at speed c increasing linearly with frequency. At light speeds much greater than c, γₛ begins to grow linearly with incremental vₛ, causing total photon energy to increase linearly.).

Velocity Addition

Einstein developed a longitudinal velocity addition formula by dividing the Lorentz transformation for dx by the Lorentz transformation for dt, and subsequently dividing both numerator and denominator by dt′. Since all terms in the Lorentz transformations are preceded by γ, both numerator and denominator also can be divided by γ to eliminate these factors. The basic concept is that vdt′ represents movement of the IRF and dx′ represents movement within the IRF. When these terms are divided by dt′, v is simply the velocity of the IRF measured in meters per second, and dx′/dt′ is the velocity of an element, such as light, within the IRF measured in meters per second′. Since the mathematics of the Lorentz transformations require length contraction, Einstein's velocity addition formula would be erroneous if length contraction did not exist.

The alternative longitudinal velocity addition formula assumes that length contraction does not exist. It can be derived by dividing the first two alternative transformations by γₛdt′, renaming dx′/dt′“v₂′”, and computing γₛ with speed v₁.

$$\frac{dx / {γ}_{s} {dt}^{′}}{dt / {γ}_{s} {dt}^{′}} ( alt velocity addition ) = ( {γ}_{s} {v}_{2}^{′} + {v}_{1} ) / ( 1 + {v}_{2}^{′} {v}_{1} / {γ}_{s} {c}^{2} ) \qquad ( 26 )$$

It is important to note that is measured within the moving IRF in meters per second′. When γₛv₂′=−v₁ then dx/dt=0. Interestingly, when light travels within a moving IRF at speed v₂′=c meters per second′, the longitudinal velocity addition formula predicts that the total speed at which light moves through the IRF, relative to an outside observer's reference frame, will be γₛc. This is consistent with the postulate of this paper.

When velocity v₁ is negative, the IRF moves opposite to the direction of light. The velocity addition formula, and the alternative transformations, predict that light will travel a distance γₛ² dx′ minus γₛvdt′ (due to negative v₁). The combined distance will be less than the distance traveled when v₁ is positive, but the time required to reach the approaching target within the IRF will also be less; and the value of dx/dt will again be γₛc. This means that, as in Einstein's model, light originating within an IRF will travel longitudinally at the same speed, as seen by an outside observer, regardless of the direction of IRF motion. Similarly, when IRF motion is in the positive x-direction, but light travels in the opposite direction (negative dx′), the resulting longitudinal light speed, as seen by an outside observer, will be negative γₛc (negative x-direction); but identical in magnitude as when light travels in the same direction as IRF motion.

Einstein's formula for transverse velocity addition was derived by assuming that dy=dy′ (no length contraction in the transverse direction), that dy can be divided by the value of dt derived from the Lorentz dt equation, and that numerator and denominator are divided by dt′, to derive transverse velocity. However, given that the Lorentz dt equation pertains to longitudinal travel, where the computed forward and backward travel times are not equal (+v versus−v), the computed speeds for transverse light traveling distally versus medially will be different. If both the forward and backward travel times are combined in a time-weighted average, Einstein's transverse velocity addition formula yields an accurate average round-trip velocity. In view of these caveats, the analogous formula in alternative model is,

$$\frac{dy}{dt \text{?}} ( alternative velocity addition ) = \frac{{v}_{y 2}}{( {γ}_{s} \pm \frac{{v}_{x 1} {v}_{x 2}^{′}}{{c}^{2}} )} \\ \text{?} \text{indicates text missing or illegible when filed} \qquad ( 27 )$$

If the “object” traveling at velocity v_{y2} is light traveling at speed c, then the formula yields the correct y-component of velocity when a combined, time-weighted average dtₓ is computed for IRF motion in the x-positive and x-negative directions.

When v_{y2}=c and vₓ₁=0, then γₛ=1, and dy/dt=c. When vₓ₂′=0 and vₓ₁≠0 then

$$\frac{dy}{{dt}_{x}} = \frac{{v}_{y 2}}{γ \text{?}}$$

$$\text{?} \text{indicates text missing or illegible when filed}$$

Refractive Index

Light travels at different speeds through different substances according to the formula,

c_{medium}=c/n

where n is the refractive index of the medium. The refractive index for water is 4/3, and for glass approximately 3/2. Light travels slower in these media than it does in a vacuum. In 1859 Fizeau reported an experiment [²⁷] showing the impact that the movement of water has on the speed of light passing through the water. Fizeau derived a formula describing the relationship between the speed of the water and the speed of the light passing through it,

$${c}_{medium} = c / n \pm v ( 1 - \frac{1}{{n}^{2}} )$$

(28)
   This formula seemed to confirm Fresnel's “partial aether drag” hypothesis [²⁸].

However, in 1907, Max von Laue proposed [²⁹] that Fizeau's equation was actually the first term in a series expansion of Einstein's velocity addition formula in which the speed of light through a medium is v₂=c/n,

$$c \text{?} = \frac{\frac{c}{n} + v}{1 + \frac{\frac{vc}{n}}{{c}^{2}}} = \frac{\frac{c}{n} + v}{1 + \frac{v}{cn}} = \frac{c ( \frac{1}{n} + \frac{v}{c} )}{1 + \frac{v}{cn}} \\ \text{?} \text{indicates text missing or illegible when filed} \qquad ( 29 )$$

and where v is the velocity of the medium relative to a stationary observer. The concept is that once light enters the refractive medium, it has entered a moving IRF where v is the speed of the IRF and c/n is dx′/dt′ within the IRF. Therefore an observer traveling within the IRF, along with the moving medium, would measure light to travel at speed c/n meters per second′. It should be noted that the apparatus containing the medium does not move, only the medium within the apparatus moves. Therefore the pathlength within the apparatus is equal to dx, not dx′. Equation ((2) yields a combined velocity as seen from the stationary frame, dx/dt, measured in meters per second.

Although the scientific community seems to have accepted Equation (29), there is no definitive proof [³⁰]. Moreover, Equation (29) behaves peculiarly for values of v≤−c/n (see FIG. 7). For example, when v=−c/n, light encounters water moving towards it at the speed that light travels in stationary water, at which point Equation (29) predicts that light comes to a complete stop. That may be possible, but as the antiparallel speed of water is increased, Equation (29) predicts that light reverses direction, and not only begins to travel backwards, but does so far faster than the incremental speed of the oncoming water. This would suggest that the special relativity velocity addition formula, and a series expansion of it to extend the Fizeau formula, are not applicable.

The alternative longitudinal velocity addition formula for light traveling through a refractive medium (ignoring dispersive terms) utilizes:

γₘ=\sqrt{1+vₘ²/c²}

where vₘ is the speed of the medium relative to the stationary frame. The observed speed of light originating in the stationary frame and passing through the medium is given by Equation (Error! Reference source not found.).

$${c}_{medium , alternative} = {c}_{m} = \frac{{γ}_{m} c ( \frac{1}{n} + \frac{{v}_{m}}{{γ}_{m} c} )}{1 + \frac{{v}_{m}}{{γ}_{m} cn}} \qquad ( 30 )$$

Here, the dx transformation of the alternative model contains the equivalent of a γₘ²dx′ term that, once divided by γₘdt′ produces the γₘc/n term in the numerator. The speed of light within the moving medium remains dx′/dt′=c/n; but the stationary frame speed becomes γₘc/n, as opposed to c/n for special relativity, because the alternative model does not contract lengths by a factor of gamma. The equivalent vₘγₘdt′ term of the alternative dx transformation becomes vₘ after division by γₘdt′; and it represents the extra distance that the medium travels while light traverses the full dx length of the apparatus, as opposed to light traveling a shorter distance of dx′ if the medium is stationary (when light is traveling in the direction of the moving medium).

When n>1, Equation (30) predicts a gradual slowing of light speed with increasing refractive medium speed, but, unlike the von Laue formula, not a reversal of direction when medium speeds are less than or equal to c. The original (not expanded) Fizeau formula predicts similar behavior as Equation (30) (see FIG. 7). Moreover, Equation (30) predicts a fairly symmetric distribution of light speeds, centered around c/n, for positive and negative water velocities. For example, when v/c=+0.6 and −0.6, the unweighted average speed of light through water using Equation (30) is approximately 0.756 c, which is very close to the speed of light in still water, 0.750 c. However, the unweighted average speed of light using Equation (29) is approximately 0.601 c. This is peculiar, since one would expect the impact of a moving medium on differential light speed to be symmetrical with respect to the velocity of the medium's motion.

Note that when n=1, then cₘ equals γₘc. And if vₘ=0, then cₘ=c/n.

Impact of Refractive Media on Doppler Effect

The passage of light through refractive media will change the speed and wavelength of light, but not its frequency. The number of waves exiting a lens or atmosphere each second will equal the number of waves entering the lens or atmosphere each second. Therefore the frequency of light passing through a medium in the stationary frame, fᵣ, will be governed by Equation (19).

The general equation for wavelength in the stationary frame will be

$${λ}_{r} ( longitudinal , Doppler ) = \frac{{c}_{m}}{{f}_{r}}$$

where cₘ is governed by Equation (30).

It is worth noting that most experiments involving the measurement of wavelength cause light to pass through a stationary lens and/or an atmosphere before measurement. When light exits a lens and passes through stationary air, which has a refractive index of approximately 1, γₘ will approximately equal 1, and its speed will be cₘ=c. Therefore, superluminal light emitted from a moving source will be slowed to speed by passage through air. And when the source moves longitudinally, wavelength after passage through stationary air will be,

$${λ}_{r , air} = \frac{c}{{f}_{r}} = {γ}_{s , s} {λ}_{0} ( 1 - \frac{{v}_{s}}{{γ}_{s , s} c} ) \qquad ( 31 )$$

The vₛ/γ_{s,s}c ratio is determined by the speed of the moving source as a fraction of the speed of light in vacuum. The refractive medium does not change this ratio because light reaches the medium after this ratio has been established, and therefore the medium does not change light's frequency. Interestingly, the formula for stationary receiver wavelength is similar to Einstein's equation for the longitudinal Doppler effect.

$${λ}_{r} ( SR ) = γ \text{?} {λ}_{0} ( 1 - \frac{v \text{?}}{c} )$$

$$\text{?} \text{indicates text missing or illegible when filed}$$

where vₑ is the longitudinal velocity in the Einstein model. As with energy, these formulas produce the same result if vₑ=vₛ/γ_{s,s}. Of note, the arithmetic mean and geometric mean of the alternative and Einstein's wavelength formulas equal (γ_{s,s}λ₀ and λ₀) and (γ_{L,e}λ₀ and λ₀) respectively.

Experimental Validation

Even though special relativity theory appears to have some flaws, experiments performed to date have yet to overturn it. The Ives Stilwell experiment [6] measured both a first and higher order longitudinal Doppler effect on wavelength at a longitudinal source velocity of about 0.3% c. Since light emitted by the fast moving hydrogen source (moving source, stationary receiver) passed through glass lenses and air prior to measuring wavelength, the equation for non-vacuum wavelength, Equation (31), is applicable. This means that the predictions of special relativity and of the alternative model will differ only by the difference between γ_{L,e} and γₛ on the higher order term

higher order difference=λ₀(γ_{s,s}−γ_{L,s})

and γ_{L,e}vₑ versus vₛ on the first order term

$$first order difference = \frac{{γ}_{L , s} {λ}_{0} v \text{?}}{c} - \frac{{λ}_{0} {v}_{s}}{c}$$

$$\text{?} \text{indicates text missing or illegible when filed}$$

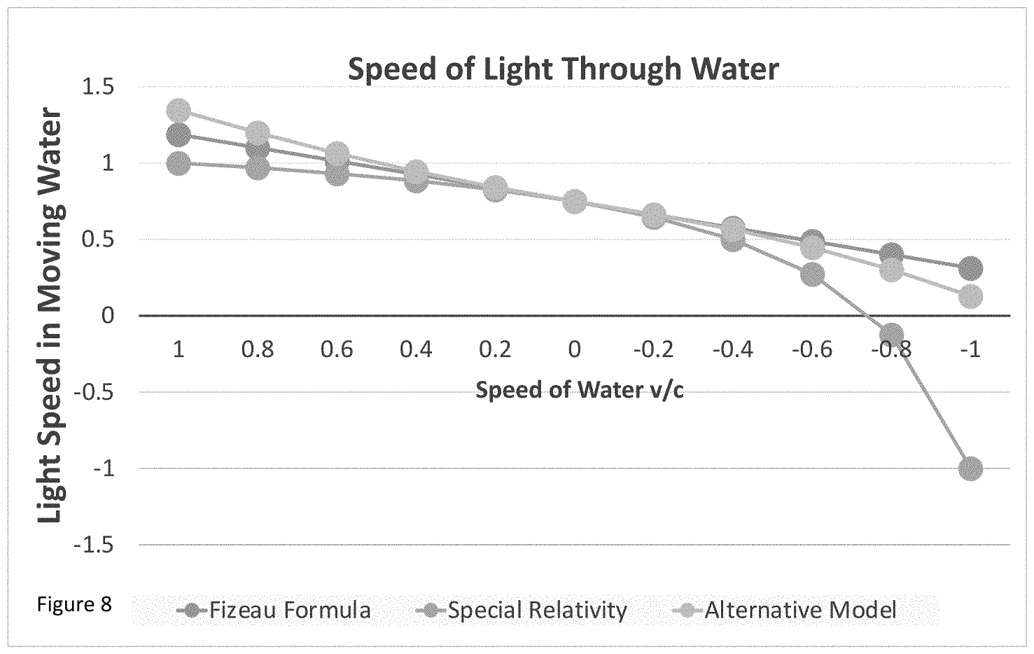

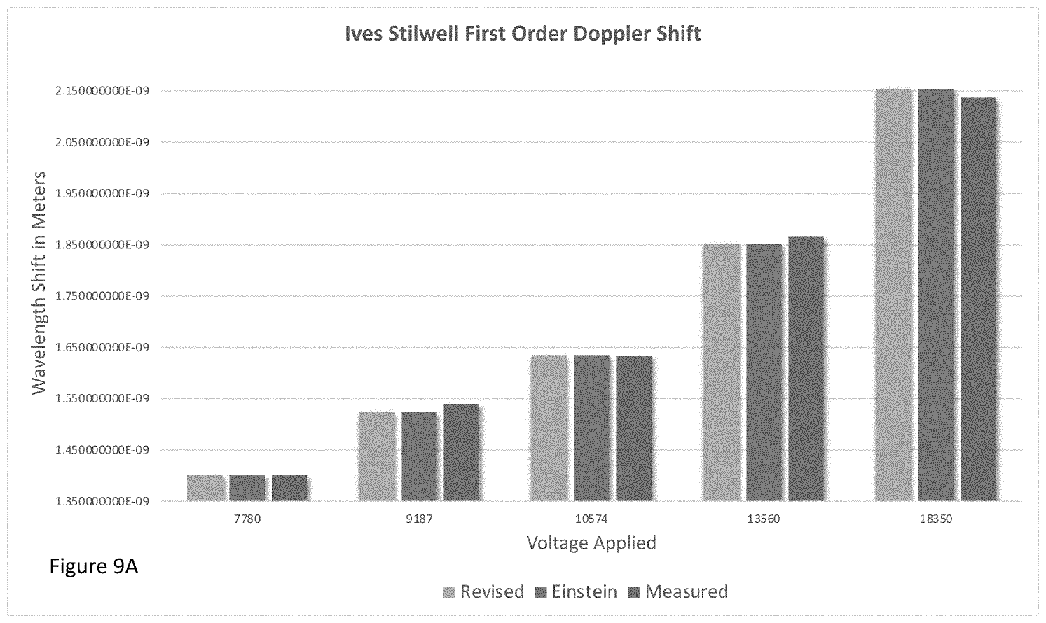

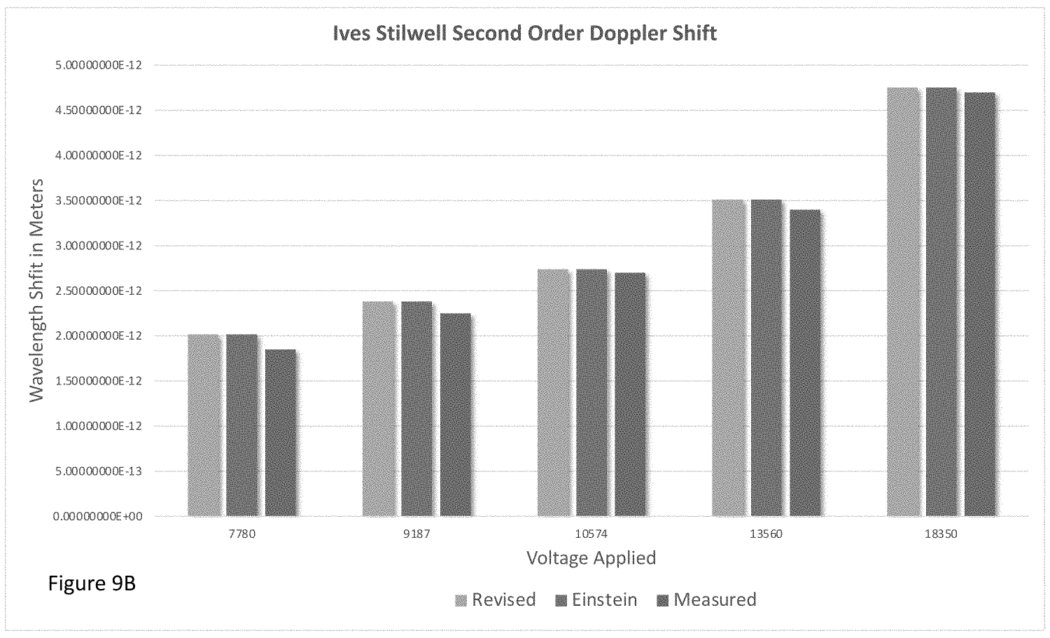

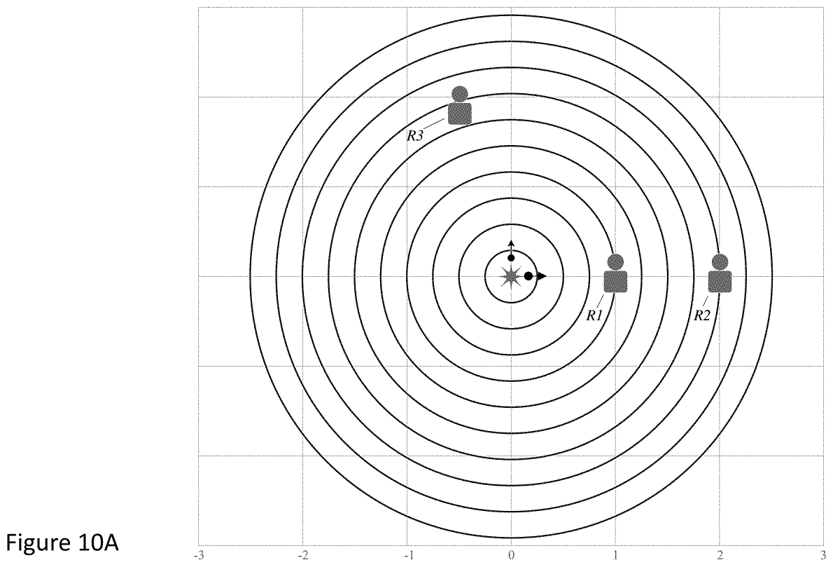

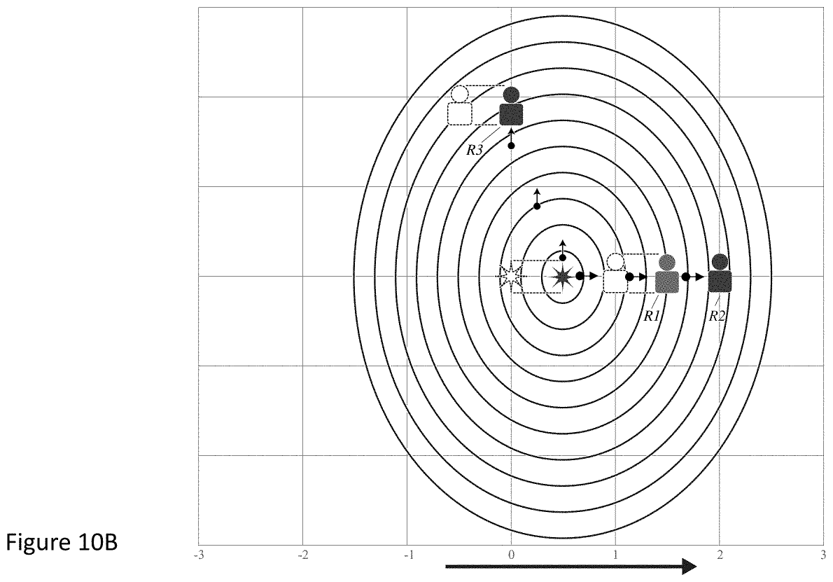

At 0.3% c, these gamma factors differ at the 11^{th} decimal place, a difference that would have been undetectable using their instrumentation. Both models agree with the experimental data, which demonstrates Doppler shifts with standard deviations of approximately 1% for the first order shift and 3% for the higher order shift. FIGS. 8a and 8b show the first and higher order wavelength shifts computed using the alternative model, Einstein's model, and the actual measurements made by Ives and Stilwell (Irrespective of the limitations of the Ives Stilwell experiment, the alternative model predicts different wavelengths for longitudinal versus transverse light in a vacuum coming from the same moving source. On Earth, the wavelengths would be made identical by the refractive index of air. But in the vacuum of space, the difference would also not be noticeable with today's instrumentation. The speed at which the Earth orbits the sun is approximately 0.01% of c, yielding a value of 1.000000005 for both γₛ and γ_{L}. This would create a difference in longitudinal versus transverse visible light wavelengths on the order of approximately 10⁻¹⁵ meters. This distance is 3 to 4 orders of magnitude below the current detection limits of the most sensitive spectrographs. It is estimated that our solar system travels with respect to the cosmic microwave background radiation at approximately 10 times this rate, which would still result in undetectable differences in longitudinal versus transverse wavelengths. Therefore, at the natural speeds of the bodies within our solar system, the difference between longitudinal versus transverse wavelengths would be difficult to detect.).

Since the gamma factors of special relativity and the alternative model are so similar at low speeds, an experiment involving much higher speeds is needed to differentiate them. Several sets of experiments have measured the impact of the first and higher order longitudinal Doppler effects on frequency from excited ⁷Li+ atoms traveling at up to one third of c [7,8,9].

Botermann et al [9] accelerated ⁷Li+ atoms to a kinetic energy of 58.6 MeV/u. The rest energy for these ions is,

Eᵣₑₛₜ=mc²=6.536×10³M eV

The ratio of Eₜₒₜₐₗ divided by mc² (Eᵣₑₛₜ) is equal to γ_{L,e} and γₛ, depending on the model. For 58.6 MeV/u of kinetic energy, this ratio becomes,

$$\frac{{E}_{total}}{{E}_{rest}} = \frac{6.536 \times {10}^{3} + 7 \times 58.6}{6.536 \times {10}^{3}} = 1.062758 = {γ}_{L , s} = {γ}_{s}$$

Velocities can be computed corresponding to this energy ratio,

$$v \text{?} = c \sqrt{1 - \frac{1}{{γ}_{L , s}^{2}}} = c \sqrt{( 1 - {( \frac{{E}_{r}}{{E}_{t}} )}^{2} )} = 0.33855 c$$

$$v \text{?} = c \sqrt{γ \text{?} - 1} = c \sqrt{{( \frac{{E}_{t}}{{E}_{r}} )}^{2} - 1} = 0.3598 c$$

$$Therefore , \\ \frac{{v}_{s}}{{v}_{s , SR}} = \frac{{v}_{s}}{v \text{?}} = 1.062758 = {γ}_{L , s} = γ \text{?}$$

$$\text{?} \text{indicates text missing or illegible when filed}$$

The experimental setup in Botermann et. al. allowed the authors to measure the maximal excitation frequencies for the moving ions, which are governed by the equations for moving receivers,

$$\frac{{f}_{r}^{′}}{{γ}_{s , r} ( 1 \pm \frac{{v}_{s}}{c} )} = {f}_{source} \qquad ( 28 )$$

They excited the ⁷Li+ ions with two laser sources, one aimed parallel to the direction of the ion beam, and one antiparallel. They determined the excitation frequencies at which each laser maximally excited the ions by detecting emitted light with photomultiplier tubes (PMTs) positioned transversely with respect to the beam (It is important to note that the stimulating laser light originated in the lab frame, and therefore traveled at c meters per second.).

Botermann et al used the following equation to determine whether the system was obeying special relativity theory,

$$\frac{{f}_{a} {f}_{p}}{{f}_{0 , 1}^{′} {f}_{0 , 2}^{′}} = \frac{1}{{γ}_{L , s}^{2} ( 1 - \frac{{v}_{s}^{2}}{{c}^{2}} )} = 1$$

where fₐ and fₚ represent the observed maximal antiparallel and parallel excitation frequencies for the moving ions in waves per second, and f_{0.1}′ and f_{0.2}′ represent two different maximal excitation frequencies for stationary ⁷Li+ ions in waves per second′ (Even though the ⁷Li+ ions were moving rapidly, their core emission and absorption frequencies remain numerically the same when measured in moving frame waves per second′ as the core emission and absorption frequencies of stationary ⁷Li+ ions. In other words, fᵣ′ (waves per second′) will be numerically the same as f₀ (waves per second). But when fᵣ′ is converted to lab frame units of waves per second, f_{r,s}′=fᵣ′/γ=f₀′/γ waves per second.). Although the equation above was found to equal unity with the experimental data, it should be noted that the following equation would also equal unity.

$$\frac{{f}_{a} {f}_{p}}{{f}_{0 , 1}^{′} {f}_{0 , 2}^{′}} = \frac{1}{{γ}_{s , s}^{2} ( 1 - \frac{{v}_{s}^{2}}{{γ}_{s , s}^{2} {c}^{2}} )} = \frac{1}{{γ}_{s , s}^{2} ( 1 - \frac{{v}_{s}^{2}}{{c}^{2}} )} = 1$$

where for longitudinal motion, γ_{s,s}²=1+γ_{L,e}²vₑ²/c².

The authors reported, “The ⁷Li+ ions are generated in a Penning ion gauge (PIG) source and accelerated by the GSI accelerator facility to a final energy of 58.6 MeV/u, which corresponds to a velocity of β=0.338.” Assuming the authors measured a velocity of β=0.338, this combination of energy and velocity, irrespective of the frequency data, would suggest that γ_{L,e} is the appropriate gamma factor for this experimental setup, not γ_{s,s}. It should be noted, however, that the magnetic field used to accelerate the ions to their final velocity pointed in a direction transverse to the direction of ion motion, and “traveled” or “communicated” with the ions at speed c. Such a field cannot accelerate an ion to a speed greater than c, and ions would approach speed c asymptotically [³¹,³²,³³].

In other words, an ion traveling at, is associated with the same amount of energy as an ion that has been accelerated in a magnetic field to velocity vₑ=vₛ/γ_{L,e}. The use of γ_{L,e}vₑ in Einstein's energy-momentum relation is consistent with the use of γ_{L,e}vₑ in Einstein's relativistic Doppler equations, and is necessitated by the inability of electromagnetic fields to accelerate charged particles to speed c and beyond, even with ever-increasing amounts of energy. The extra energy required to bring the speed of such particles asymptotically toward c is represented in the γ_{L,e} term preceding vₑ, and is reflected in the emission speed of photons from particles accelerated to speed vₑ. The alternative model captures the value of γ_{L,e}vₑ in the single term vₑ, covering more general conditions where accelerating forces may or may not be limited to a delayed action communicated at speed c.

Botermann et al reported that the rest frame transition wavelength for the ⁷Li+ ions is 548.5 nm, and that the rest frame transition frequency is 5.465×10¹⁴ waves per second, yielding a light speed of c meters per second. In order for the moving ⁷Li+ ions to observe a light speed of c meters per second′, the moving frame wavelengths must be contracted, as governed by the special relativity equation,

$${λ}_{r , SR}^{′} = \frac{{λ}_{0}}{{γ}_{L , r} ( 1 + \frac{{v}_{r}}{c} )} = {λ}_{0} \frac{\sqrt{1 - \frac{{v}_{r}}{c}}}{\sqrt{1 + \frac{{v}_{r}}{c}}}$$

Therefore, the wavelength observed by the moving ⁷Li+ ion receivers, λ_{r,SR}′, must be length contracted by γ_{L,r} in order for the receivers to observe a light speed of c meters per second′. This means that the length of the section of the Experimental Storage Ring (ESR) (The ESR has a circumference of approximately 108 meters) in Darmstadt lying between the parallel and antiparallel lasers would have to physically contract by approximately 6% for each and every excitation and emission in order for the special relativity model to be valid. Each excited particle would demand its own length contraction event. If many particles are being excited at the same time, multiple overlapping contractions of the ESR, involving different contracted distances for each particle-laser interaction, in both directions, must occur simultaneously. Since the lasers are attached to the storage ring, the storage ring itself must contract, not merely the space within the ring. This fantastic requirement does not call into question the validity of the results presented by Botermann et al, but it brings serious doubt to the validity of the constancy of the speed of light postulate of the special theory of relativity, and the concept of length contraction.

It is known that objects within the universe are moving at speeds that exceed c. Astronomers compute z-parameters according to the standard formula, where here a positive value for v means that the source is moving away from the receiver,

$$z ( Einstein ) = \frac{{λ}_{r}}{{λ}_{0}} - 1 = γ ( 1 + \frac{v}{c} ) - 1 = \frac{\sqrt{1 + \frac{v}{c}}}{\sqrt{1 - \frac{v}{c}}} - 1$$

It is assumed that λ₀ is the emission wavelength of a source at rest, and λᵣ is the observed wavelength. The z-parameter is used to measure “red shifts” and “blue shifts” of light from receding and approaching celestial bodies, respectively. The z-parameter is intended to gauge the degree to which a star's observed wavelength deviates from the presumed original resting emission wavelength, which is governed by the atoms or molecules emitting light.

Astronomers compute a star's/galaxy's velocity from the z-parameter using,

$$v / c ( Einstein ) = \frac{{( z + 1 )}^{2} - 1}{{( z + 1 )}^{2} + 1}$$

Consistent with Einstein's postulate regarding the speed of light, v/c does not exceed 1 regardless of how large z is observed to be.

One formula for the z parameter for the alternative model is,

$$z ( alternative , vacuum ) = \frac{{λ}_{r}}{{λ}_{0}} - 1 = {γ}_{s} ( {γ}_{s} + \frac{v}{c} ) - 1$$

This formula holds for a stationary source transmitting light to a moving receiver, regardless of whether light passes through a refractive medium first; and also for a stationary receiver and moving source, provided that light never passes through a refractive medium

A star's velocity can be computed from this alternative z-parameter using,

v/c(alternative,vacuum)=z/\sqrt{2z+1}

However, if the light from moving sources first passes through a stationary lens, and/or Earth's atmosphere, or other refractive media, then its speed will be slowed to c, and its wavelength will be governed by

$$λ ( alternative , media ) = {λ}_{0} ( {γ}_{s} + \frac{v}{c} )$$

For such wavelengths, the z parameter will be

$$z ( alternative , media ) = ( {γ}_{s} + \frac{v}{c} ) - 1$$

A source's velocity can be computed from such a z-parameter using,

$$v / c ( alternative , media ) = \frac{{( z + 1 )}^{2} - 1}{2 ( z + 1 )} \qquad ( 32 )$$

Table 2 lists some sample z values with corresponding v/c values for special relativity and the alternative model for light from a source moving longitudinally with respect to the Earth, and that has passed through a refracting medium prior to measuring wavelength (which is the most likely scenario for astronomical measurements).

TABLE 2
z-values, and computed v/c values for light that
has traveled through a refracting medium.

| Value of z | v/c Alternative | v/c Einstein |
|---|---|---|
| 0.001 | 0.0009995 | 0.0009995 |
| 0.01 | 0.0099505 | 0.0099500 |
| 0.1 | 0.0954545 | 0.0950226 |
| 0.5 | 0.4166667 | 0.3846154 |
| 1.0 | 0.7500000 | 0.6000000 |
| 1.25 | 0.9027778 | 0.6701031 |
| 1.5 | 1.0500000 | 0.7241379 |
| 2 | 1.3333333 | 0.8000000 |
| 5 | 2.9166667 | 0.9459459 |
| 10 | 5.4545455 | 0.9836066 |

In the alternative model, v/c can exceed 1. The largest z-value measured to date is approximately 11, which would translate to a recession velocity of about 5.96 times c, and a longitudinal light speed of about 6.04 c. The alternative model therefore provides an alternative to the hypothetical “expansion of spacetime”, and instead allows matter and energy to have superluminal recession speeds through stationary space without invoking expansion of space or spacetime. The alternative model also increases the theoretical radius of the “observable universe”, since γₛc will always exceed v.

If v/c>c for an approaching emitter, the emitter will be traveling near the speed of the longitudinal light that it emits. If an emitter originates far away from a receiver, the light coming from the emitter may not have reached the receiver. Although the majority of visible stars and galaxies appear to be receding, it is possible that another set of stars and galaxies are approaching Earth at speeds exceeding c. For example, if a source travels at 5c, the longitudinal light that it emits will travel approximately 2% faster than the source itself. Light coming from a distant source of this type might not have had time to reach the Earth and, as such, may not yet be visible. Moreover, the light emitted from sources moving transversely will travel at speed c. It will take much longer for such light to reach the Earth, and therefore such objects may not be visible from the Earth.

The superluminal speeds attainable with the alternative model help to explain a visible universe that is larger, in light years, than the presumed age of the universe. And if gravitational forces emitted from sources moving longitudinally with respect to an object upon which the source interacts travel at γₛc, there are implications for the Lambda-CDM model for cosmology.

Michelson Morley and Kennedy Thorndike

The Michelson Morley and Kennedy Thorndike experiments involved passing light through beam splitting glass, and then air, prior to measuring potential differences in travel time. As shown in Equation (30) for light passing through refracting media (glass, air), the speed of light will be determined in part by the γₘ term, which is dependent on the velocity of the media with respect to the stationary frame. Both experiments attempted to detect the impact of differences in the velocity of the Earth on travel time. According to Equation (30) light will travel through air at approximately γₘc when moving in the direction of Earth's velocity, as seen by a stationary observer in space, and at c when moving in a direction in which the velocity of the medium is zero in the direction of light travel. If the angle of travel lies in between these directions, it will travel at an intermediate speed. However, the round-trip time of travel will remain the same for all angles. Therefore experiments designed to detect differences in travel time will yield null results, since travel distances are similarly proportional to longitudinal versus transverse speeds; and speeds measured in the moving (laboratory) frame will be in all directions (It is interesting to note that the solution to the Michelson Morley experiment, cₓ=yₛc, is analogous to the relationship between vₛ and vₛ:vₛ=γₛvₛ. If time were to slow by a factor of γₛ in the longitudinal direction, both c and vₑ would increase by a factor of γₛ.).

Maxwell's Equations

The relationship between the speed of light and electromagnetic permittivity and permeability can be written as,

c=1/\sqrt{μₒϵₒ}

Since, under the alternative model, light that originates with an IRF is observed to travel at speed c within the IRF, Maxwell's electromagnetic equations remain the same within any IRF, regardless of its speed. An observer outside of a moving IRF will see light move faster in the longitudinal direction in vacuum, and therefore,

cₓ=γₛ/\sqrt{μₒϵₒ}

and at speed c when directed purely transverse to the direction of IRF motion,

cₜᵣₐₙₛᵥₑᵣₛₑ=1/\sqrt{μₒϵₒ}

Since, to date, all measurements of permittivity and permeability have been made within an IRF (e.g. a laboratory), or first passed through a refractive medium if originated from outside of the IRF, the relationship c=1/\sqrt{μₒϵₒ} holds. If permittivity and permeability were to be measured from a different reference frame, then the results would depend on the velocity of the moving reference frame, the absence of refractive media in the path within the measuring IRF, and the relative direction of the electromagnetic radiation with respect to the IRF of origin.

Absolute Versus Relative Frames

Special relativity's first postulate is that the laws of physics are the same in all IRFs, and an observer in an IRF should not be able to determine the velocity of the IRF. If this is true, a moving receiver should detect the same signal from a stationary source as a stationary receiver from a moving source. The argument is that neither receiver nor source knows their own velocity, and therefore cannot determine if their IRF is moving away or toward the other IRF, and vice versa.

However, Champeney, et al [21] demonstrated that stationary receivers detect a higher order red shift from moving sources, and moving receivers detect a higher order blue shift from stationary sources. In each case, one member was moving faster than the other relative to the lab frame. If, from the perspective of either member of the pair, the other member were moving, then each should have experienced a frequency shift in the same direction. But that is not what happened. There was a clear polarity to the effect consistent with a fundamental change in the emission frequency proportional to the emitter's velocity relative to the lab frame. This is strongly suggestive of a preferred frame.

The dimensional asymmetry of the proposed length contraction phenomenon, and its consequential differential impact on the higher order Doppler shift, creates a compelling argument that the laws of physics are not the same in all IRFs. FIG. 7 shows a hypothetical example with a light source and three different receivers, R1, R2, and R3. The source and receivers R1 and R3 are moving along with an IRF that is traveling at speed v; whereas receiver R2 is not moving with the IRF (In order to illustrate the perception of the higher order Doppler shift, the effect of the first order Doppler shift was not included in the diagram.). Receiver R3 is shown to be trailing the source by vdt meters in the x-direction, where dt is the time required for light to travel 90 degrees from the x-axis to the vertical position of R3, the angle being measured from the stationary frame. In this setup, light emitted at a 90 degree angle from the source should strike R3 as R3 moves to a position parallel to the x-axis where the source was located at the moment the source emitted each photon that strikes R3. This eliminates the first order Doppler effect on R3 and also causes R3 to perceive the light to be arriving at a right angle, so receiver R3 should not expect a primary Doppler effect. R3 should observe a steady stream of longer wavelength light being emitted from the source. FIG. 7A represents the relative positions of the elements before showing the effects of length contraction. FIG. 7B shows the elements along with their higher order frequency characteristics, and the effects of length contraction on wavelength. The IRF is shown to have traveled in the x-direction to illustrate which elements are within the moving IRF. Receiver R2 does not change position in the stationary frame between FIGS. 7A and 7B. According to special relativity, receiver R1 should not detect a higher order Doppler wavelength shift, as a consequence of length contraction. Receiver R1 also should not detect a change in source emission frequency since receiver R1's clock has slowed to the same clock rate as the source's. But, as seen in the Ives Stilwell experiment, receiver R2 does detect a higher order Doppler wavelength shift (after averaging the parallel and antiparallel combined wavelength shifts), which presents an inconsistency since receiver R2 detects the same waves from the same source as receiver R1. (Receiver R2 could have been located between the source and receiver R1 with the same result, so there is no validity to an argument that the distances between waves might re-expand beyond the bounds of receiver R1.) But since the wavelengths emitted by the source cannot be different for receivers R1 and R2, either lengths contract, in which case receivers R1 and R2 should both detect no red shift, or lengths do not contract, in which case both receivers should detect a wavelength red shift. Additionally, receiver R3 is moving along with the moving IRF and should detect the higher order Doppler shift (subject to change with different IRF velocities), since special relativity does not claim length contraction in a direction orthogonal to the direction of motion. Thus receivers R1 and R3 will experience different wavelengths coming from the source, the magnitude of the difference being dependent on IRF velocity. Worse yet, receiver R3's clock will beat at the same rate as the source's clock, due to the effect of velocity on time dilation; so receiver R3 will detect the same frequency as the source's emissions, measured in waves per second′, yet receiver R3 will detect longer wavelengths. And since light speed is equal to frequency multiplied by wavelength, receiver R3 will measure light to be traveling faster than c. These inconsistencies challenge the validity of both postulates of special relativity, and thus the basis for conjecturing that there is no absolute frame of reference.

Special relativity does not differentiate between its versions of Equations (9) and (10) by offering the aberration of light as an explanation for numerically different outputs. It uses c for light speed in Equation (9), which makes Equations (10) and (9) identical when vₛ=v and vᵣ=0 compared to when vᵣ=v and vₛ=0. Special relativity ignores the fact that the dimensional units for Equation (9) are waves per second′, whereas the dimensional units for Equation (10) are waves per second. Although red flags are raised when one observer measures light speed at c meters per second, while another observer measures the speed of the same light to be c meters per second′, at least these measurements come from different observers in different frames of reference where length contraction in all directions (which would also violate the special relativity model) could reconcile the measurements. However, when special relativity theory claims that the same observer at the same location and time will measure the frequency of light to be same whether denominated in waves per second or waves per second′, where the setups differ by deeming the receiver to be moving or stationary, there is a problem.

The Lorentz transformations attempt to provide for a pseudo-symmetry between the two perspectives of two different IRFs; but this requires some creative mathematics. The treatment of dx′ in the dx transformation leaves out a factor of gamma that would otherwise have been required, absent length contraction. This elimination of a gamma factor is necessary to claim the symmetry between IRF perspectives, since the dx′ transformation must have its own gamma factor in order to appear to treat distances symmetrically. In essence, the Lorentz transformations achieve the natural gamma squared transformation of travel length in two, partial steps rather than one full step, the gap being bridged by length contraction.

The alternative transformations achieve the γₛ² scaling in one step, which is what occurs without length contraction. The consequence is that, in the alternative model, the transformations for dx and dx′ do not treat travel lengths symmetrically. From one perspective, light travels the proper length. From the other perspective, light travels γₛ² further than the proper length, plus an amount consistent with the clock offset (2). A reversal of perspectives does not allow for subsequent increases of distance by another factor of γₛ². The implication is that the alternative model presumes an absolute or preferred frame of reference, where all IRF velocities are relative to it. Observers in different IRFs will still perceive relative motion between IRFs, but the laws of physics will depend on velocity with respect to an absolute frame, rather than merely to relative frames.

Given that the alternative model does not demand symmetrical perspectives between IRFs, the alternative dt′ transformation can be restated. Earlier in this paper, the alternative dt′ transformation was written using a similar logic for the Lorentz dt′ transformation to maintain some consistency prior to this paper introducing an absolute frame of reference.

dt′=γₛdt−γₛvdx/cₓ²

where γₛ represents the inverted seconds′ per second conversion. Now that symmetry is not required and an inversion is not needed, the alternative dt′ transformation can be rewritten according to an absolute frame of reference. The four alternative transformations then become,

Alternative Transformations (final)

dx=γₛ²dx′+γₛvdt′

dt=γₛdt′+γvdx′/c²

dx′=dx−vdt

dt′=dt/γₛ−v(dx−vdt)/γₛc²

In all four alternative transformations, γₛ represents either a dimensionless meters/meter when applied to distances, or seconds/second′ when applied to time. The third and fourth alternative transformations are merely the reversal of the first two, and do not attempt to portray a symmetrical swapping of perspectives.

To help understand its meaning, the second term of the alternative dt′ transformation can be rewritten as,

$$\frac{v ( dx - vdt )}{{γ}_{s} {c}^{2}} = \frac{{γ}_{s}^{2} {vdx}^{′}}{{γ}_{s} {γ}_{s}^{2} {c}^{2}} = \frac{{vdx}^{′}}{{γ}_{s} {c}^{2}}$$

where v is the speed of the moving IRF. The second terms of the dt and dt′ transformations relate to clock synchronization in moving IRFs. In the dt transformation, the second term is equal to the offset between a clock adjacent to the “rear” mirror and a clock adjacent to the “forward” mirror in FIG. 2 (2). The amount of offset as observed from the stationary frame is the velocity times the proper length divided by the speed of the means of synchronization squared (light at speed c or γₛc).

In the alternative model, clocks arranged along the axis of IRF motion are typically synchronized with an electromagnetic signal traveling at γₛc. The signal must traverse a proper distance of dx′ meters while the IRF is moving at speed v, which increases the round-trip distance between the source clock and the receiver clock by a factor of γₛ². This is the distance in the stationary frame that separates two events that observers in the moving frame believe occur simultaneously. According to the alternative dt transformation, the time difference between such events in the stationary frame is vγₛ²dx′/γₛ²c²=vdx′/c², which is the actual time offset between the two clocks, measured in seconds. This time difference can be thought of as the extra time required for the synchronization signal to travel the extra distance that the IRF moves in γₛ²dx′/γₛc seconds. v/γₛc is a ratio equal to the distance that the IRF travels divided by the distance the synchronization signal travels in any given amount of time. When this ratio is applied to the γₛ²dx′/γₛc seconds of synchronization time, the result is vdx′/c² seconds.

The vdx′/c² term can be written as γₛvdt′/γₛc=dt′v/c, where dt′=dx′/c. When looking at massive elements, like particles instead of light, the dt′ term can be replaced with dx′/vₚ′, which is the time required for particles to travel the distance dx′ in the moving frame. If the particles move at longitudinal speed γₛvₚ′ in the stationary frame, then when γₛ²dx′/γₛvₚ′ is multiplied by the ratio v/γₛvₚ′, the result is the extra time required for a massive particle to travel the average distance the IRF moves during a particle's round trip. The resulting extra time is dx′v/v′ₚ².)

Potential Experiments

An experiment that could differentiate between Einstein's theory of special relativity and the alternative model would have significant implications with respect to the speed of light, the ability to travel faster than c, the reality or non-reality of length contraction, the relationship between subatomic particle energy and speed, the relationship between light frequency and energy, and the size nd evolution of the universe.

The differences between γₛ and γ are extremely small at speeds attainable with satellites and other large scale tools, so direct measurement of the difference between longitudinal and transverse light speed will be challenging. Table 3 lists some values of γₛ and γ for various values of v/c.

TABLE 3
Comparison of y [symbol] to y for various values of v/c.

| Value of v/c | Description | y [symbol] | y |
|---|---|---|---|
| 0.000013 | GPS Satellite | 1.00000000008414 | 1.00000000008414 |
| 0.000100 | Earth Orbits Sun | 1.00000000500693 | 1.00000000500693 |
| 0.000167 | Mercury Orbits Sun | 1.00000001390813 | 1.00000001390813 |
| 0.000767 | Sun Through Galaxy | 1.00000029429590 | 1.00000029429607 |

[symbol]

indicates data missing or illegible when filed

The second terms of the alternative dt and dt′ transformations (the clock offset terms) are equal to the speed of the IRF times the proper length between clocks, divided by c² for dt or divided by γₛc²′ for dt′. The second term of the dt transformation computes the time difference between the synchronized clocks, denominated in seconds as observed from the stationary perspective. In the moving frame, the second term of the dt′ transformation is the same, except for a factor of γₛ in the denominator, which converts the numerical value of the clock offset time from seconds to seconds′. In other words, synchronized clocks differ in time by vdx′=c² stationary frame seconds, but if an observer could actually measure the amount by which the readings on the clocks differ, the observer would measure a difference of vdx′/γₛc² seconds′ on the slower-tempo, time-dilated clocks. If the Lorentz dt transformations are written in a format similar to the format of the final alternative transformations,

$$dt = {γ}_{L} {dt}^{′} + {γ}_{L} {vdx}^{′} / {c}^{2}$$

$${dt}^{′} = \frac{dt}{{γ}_{L}} - {vdx}^{′} / {c}^{2}$$

the Lorentz clock offset terms are a factor of gamma-fold greater than for the alternative model. The clock offset terms are related to the Sagnac effect, which has been measured for Earth's rotation to be approximately 207 nanoseconds for a full equatorial trip [³⁴]. The alternative dt transformation would predict such a value to be equal to vdx′/c², in seconds, and the Lorentz dt transformation would predict the value to be equal to γ_{L}vdx′/c² seconds.

If light is transmitted from a moving emitter to a moving receiver, the time for light to travel in the forward direction should be, in stationary frame seconds in the alternative model,

dt_{f}=γₛdt′+vdx′/c²

and in the Lorentz/Einstein model,

dt_{f,SR}=γ_{L}dt′+γ_{L}vdx′/c²

The return times in the alternative model would be,

dtᵣ=γₛdt′−vdx′/c²

and in the Lorentz/Einstein model,

dt_{r,SR}=γₛdt′−γ_{L}vdx′/c²

The sums of the forward and return times would be,

dt_{f}=dtᵣ=2γₛdt′

and

dt_{f,SR}=dt_{r,SR}=2γ_{L}dt′

The differences between the times would be

dt_{f}−dtᵣ=2vdx′/c²

and

dt_{f,SR}−dt_{r,SR}=2γ_{L}vdx′/c²

The ratio of the differences divided by the sums for the alternative model would be,

$$\frac{{dt}_{f} - {dt}_{r}}{{dt}_{f} + {dt}_{r}} = \frac{v}{{γ}_{s} c}$$

and in the Lorentz/Einstein model,

$$\frac{{dt}_{f , SR} - {dt}_{r , SR}}{{dt}_{f , SR} + {dt}_{r , SR}} = \frac{v}{c}$$

If the velocity of the emitter and receiver are known with precision, these ratios might determine which model more closely fits the data.

Another test of the alternative model could involve measuring the frequency and wavelength of light coming from stars and galaxies receding or approaching longitudinally, provided that the effects of refractive media can be eliminated. When cos φ=1 for longitudinal light, multiplication of frequency times wavelength produces a light speed of γ_{s,s}c. In other words, if both the frequency and wavelength of light traveling from stars approaching or receding from the Earth longitudinally could be measured in vacuum, without first passing through an atmosphere, then the product of these measurements should exceed c. It is not clear what will happen if the light is first passed through a medium such as refractive glass that is stationary with respect to the laboratory. If the light exiting the glass re-enters a vacuum, it could resume travel at γ_{s,s}c; but it is possible that it will resume travel at C from the perspective of the “laboratory”. In the latter case, wavelength would be altered and the product of frequency times altered wavelength would be c.

Kinetic energy in the alternative model is (γₛ−1)mc². If the kinetic energy of a rapidly-moving object could be measured, it may be possible to differentiate between (γₛ−1)mc² and (γ_{L}−1)mc². However, it is important that the object not be accelerated using a force that is limited to action at speed c, since this will change the relationship between applied energy and object velocity.

If two objects that move toward or away from each other at the same speed relative to the Earth send signals to each other, then the frequency received by each object should be governed by

$${f}_{r}^{′} = {f}_{s}^{′} \frac{1 + \frac{{v}_{r}}{{γ}_{s , s} c}}{1 - \frac{{v}_{s}}{{γ}_{s , s} c}}$$

Note that γ_{s,s} is computed using source speed in both instances. Therefore this ratio should be different than

$${f}_{r , SR}^{′} = {f}_{s , SR}^{′} \frac{1 + \frac{{v}_{r}}{c}}{1 - \frac{{v}_{s}}{c}}$$

which is what would be predicted by special relativity. Creation of an interference pattern between source and receiver signals might allow the detection of these differences.

Unfortunately, particle accelerators that use electromagnetic radiation as the accelerating force are not likely to reveal the difference between the models due to the properties of electromagnetic radiation. Even if the accelerating force were applied longitudinally rather than transversely, the force would still operate at speed c in the stationary, laboratory frame and would show the same limitations.

A mechanical force, such as a centrifugal force used in the Mossbauer experiments (21) might reveal the difference between γₛ and γ_{L}. However the detector would need to detect photons emitted at right angles to the radius of the centrifugal device (traveling longitudinal to the direction of motion at the instant of emission). Perhaps a strobe-type emission at the instants that the source and receiver are positioned at a right angle with respect to the radius would allow the detection of higher-order frequency differences, taking the arithmetic mean of the frequencies when the rotor is spun in either direction.

A Fizeau experiment would require a medium to travel nearly 0.1% of c to produce a differential shift of one tenth of a fringe unit between the special relativity model and the alternative model.

The first term of the alternative dx transformation contains a γₛ²dx′ term instead of a γ_{L}dx′ term. The difference between γₛ²−γ_{L} will grow faster than either γₛ or y_{L} as IRF speed increases. If one measures the distance that an intra-IRF light signal travels longitudinally, measured both from within the IRF and from a stationary frame, the measurements could differentiate the models. Special relativity would dictate that the light as observed from the stationary frame traveled a contracted distance. Whereas the alternative model would predict a γₛ² fold increase in distance (plus the γₛvdt′ term).

Discussion

The constancy of the speed of light has been one of the bedrocks of modern physics. All known measurements of light speed are consistent with this concept. The alternative model concurs that the speed of light as measured within an IRF is a constant, c, in all directions. The alternative model also predicts that light will move at c in a direction orthogonal to IRF movement, as seen from another IRF. The possibility that light could move at a different speed when directed other than in an orthogonal direction has been given little consideration, other than Ritz's emission hypothesis put forth in 1908 [³⁵]. The emission hypothesis has been shown to be inconsistent with experimental results, due to the fact that it utilizes a classical summation of velocities.

If it is assumed that the emission of light at the atomic level involves a phenomenon that is isotropic in all dimensions in the source's frame, then these constraints should require emissions to move at velocities proportional to the incremental distances as observed from a different frame. The alternative model hypothesizes that a source of light imparts a velocity to the emitted light in proportion to the distance a harmonic element within the source must travel in a given amount of time and in a given direction, thus causing longitudinal light to be propelled γₛ fold faster than the velocity of orthogonally transmitted light. The emission speeds would not change simply due to the motion of the observer, since the effect would be absolute with respect to a preferred frame. The motion of the observer would merely change the relative speed that light travels between source and observer.

Length contraction is problematic. In addition to the logical inconsistencies associated with the treatment of the same transverse light traveling at c meters per second and c meters per second′, one must consider the impracticality of causing materials having different compressibility to contract without provision made for the different energies required, the impracticality of causing materials to contract over distances spanning billions of light years, and the impracticality of requiring materials that are contained within overlapping IRFs and moving at different velocities to contract differentially in different dimensions. Unfortunately, the impetus to propose length contraction arose not from direct observation of length contraction itself, but from the inability or unwillingness of 19^{th} century physicists to explain the Michelson Morley experiment in a way that deviated from the belief that light must travel in circular waves through some type of homogeneous medium. It is unclear why Einstein, who initially shed the idea of a speed-defining medium, still held to the notion that light must travel at the same speed in all directions. But he did. He adopted the Lorentz transformations into special relativity, and that dictated the formula for the gamma factor used in special relativity, despite the singularity and associated problems that come with it.

Length contraction creates “paradoxes”. The “pole in the barn” paradox involves a long pole that cannot fit between two barn doors unless the pole is moving so fast that a presumed length contraction causes it to be smaller than the distance between the doors [15]. Again, there seems to be a departure from material science in the proposed solution to this paradox, calling upon an almost supernatural intervention. In the words of Minkowski, “ . . . for the contraction is not to be looked upon as a consequence of resistances in the ether, or anything of that kind, but simply as a gift from above . . . ” [³⁶], Bell's spaceship paradox [³⁷], and Elarenfest's spinning disk paradox [³⁸] present similar challenges to length contraction.

The alternative model shares none of these length related challenges. Poles do not need to squeeze into barns, trains do not need to shrink, and spacetime does not need to stretch. The alternative transformations concur with the realities of observation without invoking gifts from above.

The Lorentz transformation dt=γₜdt′+γₗvdx′/c² utilizes the factor γₗ in its second term. The second term represents the extra time required for light to travel the distance that the front clock moves from its original position while light travels between the clocks. Using the Lorentz/Einstein model, but without length contraction, this extra distance would be γ²dx′v/c; and the extra time required for light to travel that extra distance would be γ²dx′v/c². But since this result does not reconcile with the Michelson Morley result when longitudinal light travels at speed c, LFE invented length contraction to reduce the extra distance to γdx′v/c and the extra time to γdx′v/c². The γdx′v/c² term yields a different time value than the dx′v/c² clock offset term, because the latter is denominated in seconds′ in the Einstein model, and the former in seconds.

The alternative model dx=γₛ²dx′+γₛvdt′ transformation computes the expected γₛ² increase in longitudinal distance traveled, as seen from the stationary perspective; and computes an additional velocity-dependent increase in distance as a function of time, as reported in γₛdt′ seconds, as adjusted for time dilation.

The dt=γₛdt′+vdx′/c² alternative transformation reports the expected, same-location γₛdt′ passage of time as denominated in stationary seconds, plus the vdx′/c² clock synchronization term, as denominated in stationary seconds. No gamma term appears in the second term because the speed of the means being used for synchronization (longitudinal light) travels at γₛc instead of c.

The dx′=dx−vdt alternative transformation makes no pretense of being symmetric with respect to reference frames. It is simply a reversal of the dx transformation. The −vdt term subtracts the extra distance that light travels beyond dx′ as seen from the preferred frame. It is comprised of γₛvdt′, which is the extra distance that light travels as seen from the stationary perspective if events occur at the same location dt′ seconds′ apart in the moving IRF (dx′=0); plus the v²dx′/c² term, which is the extra distance the IRF travels due to the clock offset.

The dt′=dt/γₛ−v(dx−vdt)/γₛc² transformation is simply a reversal of the dt transformation. The dt/γₛ term converts the seconds that have passed into seconds′. The v(dx−vdt)/γₛc² term, abbreviated as vdx′/γₛc², converts the clock offset time into time-dilated seconds′, and subtracts them. Again, there is no pretense of symmetry between the dt′ and dt transformations.

Time dilation is an important part of the alternative model. The passage of time is generally measured by oscillating motion, and if such motion is extended over a longer path length without increasing the speed of the oscillating element, then the duration of each oscillation will increase. While time dilation's origins are not fully understood at the atomic level, oscillation frequencies will slow in response to IRF motion without the addition of energy, as observed from a stationary frame. If the center of motion of an oscillating element is to remain stationary within a moving IRF, the oscillation path length will need to be longer, as seen from a stationary frame. When the oscillations in the moving frame move orthogonal to the axis of IRF motion, the stationary frame path length will be γₛ fold longer than the path length in the moving frame. And when the oscillations in the moving frame move parallel to the axis of IRF motion, the stationary frame path length will be γₛ² fold longer. The generic value of γₛ will be dependent on the velocity of the moving IRF as seen from the stationary frame, squared, divided by the stationary frame speed of the oscillating element in the direction of IRF motion, squared,

$${γ}_{s} = \frac{1}{\sqrt{1 - \frac{{v}^{2}}{{c}_{x}^{2}}}}$$

where cₓ is the stationary frame speed of the oscillating element in the direction of IRF motion.

In order for oscillations to remain synchronized in all dimensions, the speed of the oscillating “element(s)”, as seen from the stationary frame, will need to be faster in the longitudinal dimension than in the orthogonal dimensions. This may require the addition of more energy to the system when accelerating the object containing the oscillating element.

Overall, the alternative model fits observational data as well, and sometime better than special relativity. The alternative longitudinal velocity addition formula tracks the original Fizeau equation for light speed traveling through moving refractive media more closely than the addition formula from special relativity. It also predicts “upstream” and “downstream” average speed to be approximately the speed at which light moves through stationary media; whereas the special relativity formula predicts a skewed average speed. The logical basis for such skewing is elusive. The special relativity formula also predicts that light will travel backwards when directed antiparallel to a fast moving, refractive medium; and that its backwards velocity will increase incrementally faster than incremental increases in the speed of the medium. The rationale for this is also elusive.

The alternative model is consistent with stars and galaxies traveling faster than c, which helps to explain how a universe that is approximately 90 billion light years in diameter could have formed less than 14 billion years ago. In the ACDM concordance model, objects with redshift greater than z˜1.46 are presumed to be receding faster than the speed of light [³⁹]. It may not be a coincidence that Equation (32) predicts a recession velocity of approximately the speed of light when z is equal to 1.46.

The fact that γₛ is intrinsic to the energy-momentum and the mass-energy equations is remarkable. And given the parallels between γ in Einstein's modified energy-momentum relation, mass-energy equation, and Lorentz's distance and time transformations, versus the parallels between the unmodified energy-momentum relation, the unmodified mass-energy equation, and the alternative model's unmodified distance and time transformations, there is more than ample motivation to justify experiments that will differentiate the models.

If the alternative model is found to be a more accurate description of reality, then the transmission of information and matter at superluminal speeds, and non-locality, are no longer prohibited. The alternative model opens the possibility that photons might have mass, that the relationship between energy and velocity does not suffer from a singularity, and that our understanding of the geometry, evolution, and dynamics of the universe can take on a new direction.

### REFERENCES

¹Einstein, A. On the electrodynamics of moving bodies. Annalen der Physik, 1905, Vol. 17. 891.
²Morin, D. Special Relativity. 2017. ISBN-10: 1542323517.
³Lorentz, H. A. Electromagnetic phenomena in a system moving with any velocity smaller than that of light. Proc. Acad. Sci. (Amsterdam), 1904, Vol. 6. 809.
⁴Michelson, A. A. & Morley, E. W. The relative motion of the Earth and the luminiferous aether. Am. J. Sci., 1887, Vol. 34. 333-345.
⁵Fitzgerald. The Ether and the Earth's Atmosphere. 328, s.l.: Science, 1889, Vol. 13. 390.
⁶Ives, H. E. & Stilwell, G. R. An Experimental Study of the Rate of a Moving Atomic Clock. 7, Optical Society of America, 1938, Vol. 28. 215-226.
⁷Kaivola, M., Poulsen, O., Riis, E., Lee, S. A. Measurement of the Relativistic Doppler Shift in Neon. 4, Phys. Rev. Lett., 1985, Vol. 54. 255-258.
⁸Grieser, R., Klein, R., Huber, G., Dickopf, S., Klaft, I., Knobloch, P., Merz, P. A test of special relativity with stored lithium ions. 2, s.l.: Applied Physics B, 1994, Vol. 59. 127-133.
⁹Botermann, B., et. al. Test of Time Dilation Using Stored Li+ Ions as Clocks at Relativistic Speed. 12, Phys. Rev. Lett., 2014, Vol. 113. 120405(1-5).
¹⁰Terrell, J. Invisibility of the Lorentz Contraction. 4, s.l.: Phys. Review. 116, 4, pg 1041, 1959, Vol. 226. 1041.
¹¹Rayleigh, Lord. Does Motion through the Aether cause Double Refraction? Philosophical Magazine, 1902, Vol. 4. 678.
¹²Brace, D B. On double refraction in matter moving through the aether. s.l.: Philosophical Magazine, 1904. S. 6 Vol 7, 40.
¹³Larmor, J. On the ascertained absence of effects of motion through the aether, in relation to the constitution of matter, and on the FitzGerald-Lorentz hypothesis. Philosophical Magazine, 1904. Call L42, 621-625.
¹⁴Trouton F. T., Rankine A. On the electrical resistance of moving matter. Proc. Roy. Soc., 1908. 80 (420): 420.
¹⁵Rindler, Wolfgang. Length Contraction Paradox. American Journal of Physics, 1961. 29 (6): 365-366.
¹⁶Taylor, Edwin F. and Wheeler, John Archibald. Special Relativity, Spacetime Physics: Introduction to. s.l.: New York: W. H. Freeman, 1992. p. 116.
¹⁷Wells, Willard H. Length paradox in relativity. s.l.: American Journal of Physics, 1961. 29 (12): 858-858.
¹⁸Shaw, R. Length contraction paradox. s.l.: American Journal of Physics, 1962. 30 (1): 72-72.
¹⁹Ashby, N. Relativity in the Global Positioning System. s.l.: Living Rev. Relativity, 2003. 6, 1.
²⁰Einstein, A. Uber das Relativitatsprinzip and die aus demselben gezogene Folgerungen (About the principle of relativity and the conclusions drawn from it). Jahrb. Radioakt. Elektronik 4, 411 (1907).
²¹Champeney, D. C., Isaak, G. R., and Khan, A. M. A time dilation experiment based on the Mossbauer effect. Proc. Phys. Soc. 85, 583 (1965).
²³Chou, C. W., Hume, D. B., Rosenband, T., Wineland, D. J. Optical Clocks and Relativity. s.l.: Science, 2010, Vol. 329. 10.1126/science.1192720.
²⁴Planck, M. On the law of distribution of energy in the normal spectrum. Annalen der Physik, vol. 4 p 553 (1901).
²⁵Einstein, A. On a heuristic point of view concerning the production and transformation of light. Annalen der Physik 17, 132-148 (1905).
²⁶Einstein, A. Does the inertia of a body depend upon its energy content? Annalen der Physik. 18, 639 (1905).
²⁷Fizeau. Sur Les Hypotheses Relatives A L'Ether Lumineux. s.l.: Annales de chimie et de physique, 1859, Decembre. 3 serie, LVII.
²⁸Fresnel, A. Lettre d'Augustin Fresnel à Françis Arago sur l'influence du mouvement terrestre dans quelques phénomènes d'optique. s.l.: Annales de chimie et de physique, 1818, Vol. 9. 57-66.
²⁹Laue, M. von. The Entrainment of Light by Moving Bodies in Accordance with the Principle of Relativity. 1, s.l.: Annalen der Physik, 1907, Vol. 23. 989-990.
³⁰Lerche, I. 12, s.l.: Am. J. Physics, 1977, Vol. 45. 1154-1163.
³¹Wiedemann, H. Particle Accelerator Physics. Heidelberg: Springer, 2015. ISSN 1868-4513 e-ISSN 1868-4521
³²Feynman, R. Feynman Lectures on Physics. s.l.: Addison-Wesley, 1963. 63-21707.
³³Rafelski, J. Relativity Matters. Heidelberg: Springer, 2017. 2017935709.
³⁴Allan, D W., Weiss, M. A., and Ashby, N. Around-the-World Relativistic Sagnac Experiment.
³⁵Martinez, A. Ritz, Einstein, and the Emission Hypothesis. Phys. Perspect., 2004, Vol. 6. 4-28.
³⁶H. A. Lorentz, A. Einstein, H. Minkowski and H. Weyl, translated by W. Perrett and G. B. Jeffery. The Principle of Relativity: A Collection of Original Memoirs on the Special and General Theory of Relativity. s.l.: Dover Publications, 1952. p. 81.
³⁷Bell, J. S. How to teach special relativity. s.l.: Progress in Scientific Culture, 1976. 1(2).
³⁸Ehrenfest, P. Uniform Rotation of Rigid Bodies and the Theory of Relativity. s.l.: Physikalische Zeitschrift, 1909, Vol. 10. 918.
³⁹Davis, T. M and Lineweaver, C. H. Expanding Confustion: common misconceptions of cosmological horizons and the superluminal expansion of the universe. 2003, Nov. 13. arXiv:astro-ph/0310808v2

What is claimed is:

1. A system for transmitting information from a first location to a second location, comprising:
a conduit running between the first and second locations;
a material within the conduit;
a material mover in fluid communication with the conduit;
a radiation source at the first location configured to transmit radiation through the material in the conduit; and
a radiation detector at the second location configured to detect the radiation.

2. The system of claim 1, wherein the radiation is electromagnetic radiation.

3. The system of claim 2, wherein the electromagnetic radiation is infrared, UV, or visible light.

4. The system of claim 1, wherein the conduit comprises a metal tube.

5. The system of claim 1, wherein the conduit comprises a closed loop such that material moving through the conduit from the first location returns to the first location in a return conduit.

6. The system of claim 1, where the material is a gas.

7. The system of claim 6, wherein the gas is helium.

8. The system of claim 1, wherein the material mover is a pump.

9. The system of claim 1, wherein the material mover is configured to move the material through the conduit at a speed of at least 0.001 c, wherein c is the speed of light in vacuum.

10. The system of claim 1, wherein the material mover is configured to move the material forward and backward in the conduit in an alternating fashion.

11. The system of claim 10, wherein the maximum speed of the material in the conduit is at least 0.001 c, wherein c is the speed of light in vacuum.

12. The system of claim 1, wherein the radiation source comprises a laser.

13. The system of claim 10, wherein the laser is pulse modulated.

14. The system of claim 1, wherein the conduit comprises one or more windows to permit radiation to pass in or out of the conduit.

15. A method of transmitting information from a first location to a second location, the method comprising:
providing a conduit between the first and second locations;
moving material within the conduit at a speed of at least 0.001 c, wherein c is the speed of light in vacuum; and
transmitting light encoding the information through the moving material.

16. The method of claim 15, wherein the material is a gas.

17. The method of claim 16, wherein the material is helium gas.

18. The method of claim 15, comprising moving material within the conduit at a speed of at least 0.005 c.

19. The method of claim 15, comprising moving material within the conduit at a speed of at least 0.01 c.

20. The method of claim 15, wherein moving the material comprises moving the material forward and backward in an alternating fashion, wherein the maximum speed of the alternating moving material is at least 0.001 c.

21. The method of claim 20, wherein the material is oscillated at a rate of at least 1 kHz.

22. The method of claim 15, wherein the information is encoded using pulse modulation.
